(19) United States
(12) Patent Application Publication
(10) Pub. No.: US 2008/0107828 A1
(43) Pub. Date: May 8, 2008

(54) Optically-Compensatory Sheet, Polarizing Plate And Liquid Crystal Display Device

(75) Inventors: Sumio Ohtani, Kanagawa (JP); Ikuko Ohgaru, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/886,106

(22) PCT Filed: Mar. 10, 2006
(86) PCT No.: PCT/JP06/04810

§ 371 Date: Sep. 11, 2007

(30) Foreign Application Priority Data
Mar. 11, 2005 (JP) 2005-069713
Mar. 14, 2005 (JP) 2005-071249

(51) Int. Cl. C09K 19/02; B32B 5/16; B32B 9/04; B32B 27/06; B32B 27/36

(52) U.S. Cl. 428/1.1; 428/500; 428/323; 428/473.5; 428/476.3; 428/483; 428/411.1

(57) ABSTRACT

An aim of the invention is to provide an optically-compensatory sheet having little change of optical characteristics with ambient temperature and humidity and a high degree of freedom of design of in-plane retardation Re and thickness-direction retardation Rth, and to provide a polarizing plate and a liquid crystal display device having such an excellent optically-compensatory sheet. An optically-compensatory sheet comprises an optically anisotropic layer laminated on a base film containing a cyclic olefin-based addition polymer. A polarizing plate comprises a polarizer and two sheets of protective films disposed on the respective side thereof, wherein at least one of the two sheets of protective films is an optically-compensatory sheet. A liquid crystal display device comprises at least one sheet of the polarizing plate.

### TECHNICAL FIELD

The present invention relates to an optically-compensatory sheet, a polarizing plate and a liquid crystal display device. More particularly, the present invention relates to an optically-compensatory sheet comprising a cyclic olefin-based addition polymer as a base film.

### BACKGROUND ART

A polarizing plate is typically produced by attaching a film mainly formed of cellulose triacetate as a protective film on both sides of a polarization film which is formed of iodine or a dichroic dye aligned and adsorbed to polyvinyl alcohol. Cellulose triacetate has features of being high in rigidity, flame resistance, and optical isotropy (low retardation value), and is widely used for the above-described polarizing plate protective film. A liquid-crystal display device is formed of a polarizing plate and a liquid-crystal cell. Today, TN-mode TFT liquid-crystal display devices, which are the main stream of the liquid-crystal display devices, realize high display visibility by inserting an optically-compensatory sheet between a polarizing plate and a liquid-crystal cell as described in JP-A-8-50206. However, cellulose acetate is disadvantageous in that it has a high water absorption or permeation and thus is subject to change of optical compensation properties or deterioration of polarizer. Further, TN liquid crystal display devices are disadvantageous in that they show light leakage at the four sides of the screen with the elapse of time after turning the power ON. Moreover, VA-mode liquid crystal display devices are disadvantageous in that they show light leakage at the four corners of the screen with the elapse of time after turning the power ON.

A cyclic polyolefin film has been noted as a film which can be improved in moisture absorbability or moisture permeability of cellulose triacetate film and shows little change of optical characteristics with ambient temperature and humidity and has been under development as a film to be used for polarizing plates and liquid-crystal display devices using heat fusion film formation or solution film formation. Patent Reference 1 discloses an optically-compensatory sheet comprising an optically anisotropic layer laminated on a base film formed of a cyclic olefin-based ring-opening polymerization product. However, the ring-opening polymer-based polyolefin film tends to be low in both in-plane retardation and thickness-direction retardation and thus be optically isotropic when not stretched but tends to rise in both in-plane retardation and thickness-direction retardation when stretched. Thus, the ring-opening polymer-based polyolefin film allows only simple optical compensation. Therefore, even when the ring-opening polymer-based polyolefin film is combined with an optically anisotropic layer to prepare an optically-compensatory sheet, the resulting optically-compensatory sheet has a limited degree of freedom of design of optical characteristics such as in-plane retardation and thickness-direction retardation. Accordingly, the ring-opening polymer-based polyolefin film is not suitable for improvement of viewing angle of TN liquid crystal display devices or OCB liquid crystal display devices.

[Patent Reference 1] JP-A-2004-246338

### DISCLOSURE OF THE INVENTION

### Problems that the Invention is to Solve

An aim of the invention is to provide an optically-compensatory sheet having little change of optical characteristics with ambient temperature and humidity and a high degree of freedom of design of in-plane retardation Re and thickness-direction retardation Rth. Another aim of the invention is to provide a polarizing plate and a liquid crystal display device having such an excellent optically-compensatory sheet.

### Means for Solving the Problems

The inventors made extensive studies. As a result, it was found that when a cyclic olefin-based addition polymer is used as a polymer constituting the base film of optically-compensatory sheet, in-plane retardation and thickness-direction retardation can be freely controlled, making it possible to design optically-compensatory sheets suitable for various modes of liquid crystal display devices. By modifying the structure of the cyclic olefin-based addition polymer in a base film containing a cyclic olefin-based addition polymer or stretching the base film, base films having various optical characteristics such as optically isotropic base film and base film having a great optical anisotropy can be obtained. In particular, a base film having a thickness-direction retardation which is great relative to in-plane retardation, which has heretofore been difficultly prepared, can be obtained. Thus, the degree of freedom of design of optical characteristics of optically-compensatory sheet combined with optically anisotropic layer was successfully raised.

The invention concerns the following constitutions.

(1) An optically-compensatory sheet, comprising:

an optically anisotropic layer laminated on a base film containing a cyclic olefin-based addition polymer.

(2) The optically-compensatory sheet as described in (1) above,

wherein the cyclic olefin-based addition polymer is a copolymer comprising at least one repeating unit represented by the following formula (I) and at least one cyclic repeating unit represented by the following formula (II):

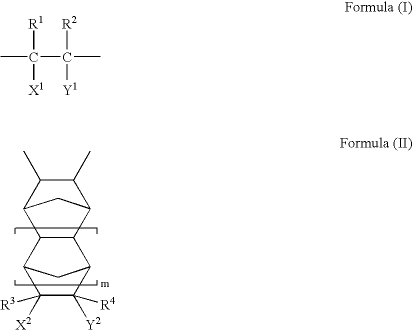

wherein m represents an integer of from 0 to 4;

R¹ to R⁴ each represents a hydrogen atom or a C₁-C₁₀ hydrocarbon group; and

X¹ to X² and Y¹ to Y² each represents a hydrogen atom, a C₁-C₁₀ hydrocarbon group, a halogen atom, a C₁-C₁₀ hydrocarbon group substituted by halogen atom, —(CH₂)ₙCOOR¹¹, —(CH₂)ₙOOCR¹², —(CH₂)ₙNCO, —(CH₂)ₙNO₂, —(CH₂)ₙCN, —(CH₂)ₙCONR¹³R¹⁴, (CH₂)ₙNR¹³R¹⁴, —(CH₂)ₙOCOZ, —(CH₂)ₙOZ, —(CH₂)ₙW or (—CO)₂O or (—CO)₂NR¹⁵ formed by X¹ and Y¹ or X² and Y² in which R¹¹, R¹², R¹³, R¹⁴ and R¹⁵ each represents a C₁-C₂₀ hydrocarbon group, Z represents a hydrocarbon group or a hydrocarbon group substituted by halogen, W represents SiR¹⁶ₚD₃₋ₚ, in which R¹⁶ represents a C₁-C₁₀ hydrocarbon group, D represents a halogen atom, —OCOR¹⁶ or —OR¹⁶ and p represents an integer of from 0 to 3, and n represents an integer of from 0 to 10.

(3) The optically-compensatory sheet as described in (1) above,

wherein the cyclic olefin-based addition polymer is a polymer comprising one cyclic repeating unit represented by the formula (II) or a copolymer comprising at least two cyclic repeating units represented by the formula (II).

(4) The optically-compensatory sheet as described in (3) above,

wherein a thickness-direction retardation Rth of the optically-compensatory sheet satisfies the following expression:
40 nm≦Rth(630)≦300 nm

wherein Rth (λ) represents Rth measured at a wavelength of λ nm.

(5) The optically-compensatory sheet as described in any of (1) to (4) above,

wherein the base film comprises a particulate material having a primary particle diameter of from 1 nm to 20 μm incorporated therein in a proportion of from 0.01% to 0.3% by mass.

(6) The optically-compensatory sheet as described in any of (1) to (5) above,

wherein the optically anisotropic layer comprises a discotic liquid crystal layer.

(7) The optically-compensatory sheet as described in any of (1) to (5) above,

wherein the optically anisotropic layer comprises a rod-shaped liquid crystal layer.

(8) The optically-compensatory sheet as described in any of (1) to (5) above,

wherein the optically anisotropic layer comprises a polymer film.

(9) The optically-compensatory sheet as described in (8) above,

wherein the polymer film constituting the optically anisotropic layer comprises at least one polymer material selected from the group consisting of polyamide, polyimide, polyester, polyether ketone, polyamide imide, polyester imide and polyaryl ether ketone.

(10) The optically-compensatory sheet as described in any of (1) to (9) above,

wherein the base film containing the cyclic olefin-based addition polymer is formed through a step of flow-casting a solution as a start raw material on an endless metal support, the solution containing the cyclic olefin-based addition polymer by 10 to 35 mass % and a fluorine-based organic solvent as a main solvent, a step of drying the solution until remaining volatility reaches 5 to 60 mass %, a step of peeling the dried solution from the metal support with peeling resistance of 0.25 N/cm or less, and a step of drying and winding up the peeled solution.

(11) The optically-compensatory sheet as described in (10) above,

wherein the fluorine-based organic solvent contains dichloromethane by 50 mass % or more, and the cyclic olefin-based addition polymer is dissolved at 20 to 100° C. to prepare the solution.

(12) The optically-compensatory sheet as described in (10) or (11) above,

wherein the solution contains a poor solvent of the cyclic olefin-based addition polymer by 3 to 100 parts by mass for 100 parts by mass of the cyclic olefin-based addition polymer.

(13) The optically-compensatory sheet as described in (12) above,

wherein the poor solvent comprises alcohols having boiling point of 120° C. or less.

(14) The optically-compensatory sheet as described in any of (1) to (9) above,

wherein the base film containing the cyclic olefin-based addition polymer contains a surfactant by 0.05 to 3 mass %.

(15) A polarizing plate, comprising:

a polarizer; and

two sheets of protective films disposed on the respective side thereof,

wherein at least one of the two sheets of the protective films is the optically-compensatory sheet as described in any of (1) to (14) above.

(16) A liquid crystal display device, comprising at least one sheet of the polarizing plate as described in (15) above.

The liquid crystal display device is preferable in any of the following forms.

(17) A TN-mode liquid crystal display device as described in (16) above,

wherein at least one of the two sheets of protective films constituting the polarizing plate incorporated in the liquid crystal display device exhibits an in-plane retardation Re (630) of 15 nm or less and a thickness-direction retardation Rth (630) of from not smaller than 40 nm to not greater than 120 nm and a discotic liquid crystal layer is laminated thereon.

(18) A VA liquid crystal display device of VA mode as described in (16) above,

wherein at least one of the two sheets of protective films constituting the polarizing plate incorporated in the liquid crystal display device exhibits an in-plane retardation Re (630) of 15 nm or less and a thickness-direction retardation Rth (630) of from not smaller than 120 nm to not greater than 300 nm and a rod-shaped liquid crystal layer is laminated thereon.

(19) An OCB liquid crystal display device of OCB mode as described in (16) above,

wherein at least one of the two sheets of protective films constituting the polarizing plate incorporated in the liquid crystal display device exhibits an in-plane retardation Re (630) of from not smaller than 30 nm to not greater than 70 nm and a thickness-direction retardation Rth (630) of from not smaller than 120 nm to not greater than 300 nm and a discotic liquid crystal layer is laminated thereon.

Re (λ) and Rth (λ) are Re and Rth measured at a wavelength of λ nm, respectively.

### ADVANTAGE OF THE INVENTION

In accordance with the invention, an optically-compensatory sheet having little change of optical characteristics with ambient temperature and humidity and a high degree of freedom of design of in-plane retardation Re and thickness-direction retardation Rth can be obtained. A polarizing plate and a liquid crystal display device having such an excellent optically-compensatory sheet can be also obtained.

In accordance with the invention, an optically-compensatory sheet and a polarizing plate having an optical compensation capacity adapted for liquid crystal display devices of various modes such as TN, VA, OCB and IPS can be prepared by adjusting the optical characteristics of a base film containing a cyclic olefin-based addition polymer.

The liquid crystal display device of the invention shows little or no light leakage with the elapse of time.

### BEST MODE FOR CARRYING OUT THE INVENTION

The invention will be further described hereinafter.

[Base Film Formed of Cyclic Olefin-Based Addition Polymer]

(Cyclic Olefin-Based Addition Polymer)

Examples of the cyclic olefin-based addition polymer include (1) norbornene-based polymers, (2) monocyclic olefin polymers, (3) cyclic conjugated polymers, (4) vinyl-alicyclic hydrocarbon polymers, and hydride of polymers (1) to (4). Preferred among these polymers are norbornene-based polymers, hydride thereof, vinyl-alicyclic hydrocarbon polymers, hydride thereof, etc. from the standpoint of optical characteristics, heat resistance, mechanical strength, etc.

The polymer which is preferably used in the invention is a norbornene-based addition (co)polymer comprising at least one repeating unit represented by the following formula (I) and at least one cyclic repeating unit represented by the following formula (II).

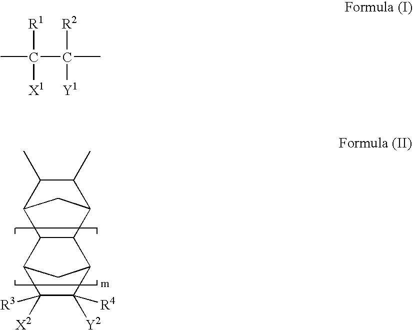

wherein m represents an integer of from 0 to 4; R¹ to R⁴ each represent a hydrogen atom or a C₁-C₁₀ hydrocarbon group; and X¹ to X² and Y¹ to Y¹ each represent a hydrogen atom, a C₁-C₁₀ hydrocarbon group, a halogen atom, a C₁-C₁₀ hydrocarbon group substituted by halogen atom, —(CH₂)ₙCOOR¹¹, —(CH₂)ₙOOCR¹², —(CH₂)ₙNCO—, —(CH₂)ₙNO₂, —(CH₂)ₙCN, (CH₂)ₙCONR¹³R¹⁴, —(CH₂)ₙNR¹³R¹⁴, —(CH₂)ₙOCOZ, —(CH₂)ₙOZ, —(CH₂)ₙW or (—CO)₂O or (—CO)₂NR¹⁵ formed by X¹ and Y¹ or X² and Y² in which R¹¹, R¹², R¹³, R¹⁴ and R¹⁵ each represent a C₁-C₂₀ hydrocarbon group, Z represents a hydrocarbon group (preferably having from 1 to 10 carbon atoms) or a hydrocarbon group (preferably having from 1 to 10 carbon atoms) substituted by halogen, W represents SiR¹⁶ₚD₃₋ₚ (in which R¹⁶ represents a C₁-C₁₀ hydrocarbon group, D represents a halogen atom, —OCOR¹⁶ or —OR¹⁶, and p represents an integer of from 0 to 3), and n represents an integer of from 0 to 10.

Norbornene-based addition (co)polymers are disclosed in JP-A-10-7732, JP-T-2002-504184, WO2004/070463A1, etc. These norbornene-based addition (co)polymers are produced by the addition polymerization of norbornene-based polycyclic unsaturated compounds or by the addition polymerization of a norbornene-based polycyclic unsaturated compound with a conjugated diene such as ethylene, propylene, butene, butadiene and isoprene, a nonconjugated diene such as ethylidene norbornene or a compound such as acrylonitrile, acrylic acid, methacrylic acid, maleic anhydride, acrylic acid ester, methacrylic acid ester, maleimide, vinyl acetate and vinyl chloride. This norbornene-based addition (co)polymer is commercially available from Mitsui Chemicals, Inc. in the trade name of “Apel.” Grades of Apel include those having different glass transition temperatures (Tg), e.g., APL8008T (Tg:70° C.), APL6013T (Tg:125° C.), APL6015T (Tg: 145° C.). Further, pelletized norbornene-based addition (co)polymers are commercially available from Polyplastics Co., Ltd. in the trade name of TOPAS8007, TOPAS6013, TOPAS6015, etc.

In the norbornene-based addition (co)polymer of the invention, the molar ratio of the repeating unit represented by the formula (I) to the cyclic repeating unit represented by the formula (II) is from 0:100 to 90:10, preferably from 0:100 to 70:30.

More preferably, the norbornene-based addition (co)polymer of the invention is a polymer comprising at least one cyclic repeating unit represented by the formula (II) or a copolymer comprising at least two cyclic repeating units represented by the formula (II). In the case where the norbornene-based addition (co)polymer of the invention is a copolymer comprising at least two cyclic repeating units represented by the formula (II), it is preferred that one of the substituents X²'s and/or Y²'s be a hydrophilic group or a group having a high polarity while the other be a hydrophobic group or a group having a low polarity. This arrangement exerts an effect of controlling the hydrophilicity or water permeability of film.

Further, by modifying the structure of the cyclic olefin-based addition polymer of the invention or stretching the base film, base films having various optical characteristics such as optically isotropic film and base film having a great optical anisotropy can be obtained. In particular, a base film having a thickness-direction retardation which is great relative to in-plane retardation, which has heretofore been difficultly prepared, can be obtained. In some detail, the modification of the structure of the norbornene-based addition (co)polymer, if conducted, is preferably carried out by reducing the proportion of the repeating unit of the formula (I) and raising the proportion of the repeating unit of the formula (II). The stretching of the base film, if conducted, can be carried out by a method which is used for cellulose acylate film, e.g., tenter stretching. By properly changing the stretching ratio, desired optical characteristics can be obtained.

(Additive)

Various additives (for example, a deterioration preventive agent, an ultraviolet absorber, a retardation (optical anisotropic) control agent, particles, a peel promoting agent, an infrared absorber, etc.) depending on use in various preparing processes may be added to the cyclic olefin-based addition polymer solution of the invention and may be in solid or oil state. That is, these additives are not particularly limited in a melting point or a boiling point. For example, an additive used may be a mixture of ultraviolet absorptive materials at more than 20° C. and less than 20° C. or a mixture of deterioration preventive agents at the same temperatures. In addition, an infrared absorptive dye is disclosed in, for example, Japanese Patent Application Publication No. 2001-194522. The additive may be added in the middle of a dope manufacturing process or at the last step of the dope manufacturing process. The addition amount of the additive is not particularly limited as long as it functions well. If the base film containing the cyclic olefin-based addition polymer (hereinafter also referred to as a base film of a cyclic olefin-based addition polymer, or cyclic polyolefin) is multi-layered, the kind and amount of additives in each layer may be varied.

(Deterioration Preventive Agent)

Deterioration (oxidation) preventive agents, for example, phenol-based or hydroquinone-based antioxidants, such as 2,6-di-t-butyl, 4-methylphenol, 4,4′-thiobis-(6-t-bytyl-3-methylphenol), 1,1′-bis(4-hydroxypenyl)cyclohexane, 2,2′-methylenebis(4-ethyl-6-t-butylphenol), 2,5-di-t-butylhydroquinone, pentaerytrityl-tetrakis[3-(3,5-di-t-butyl-4-hydroxypenyl)propionate and the like, may be added to the base film of the cyclic olefin-based addition polymer of the invention. In addition, it is preferable to add phosphorus-based antioxidants such as tris(4-methoxy-3,5-dipenyl)phosphite, tris(nonylpenyl)phosphite, tris(2,4-di-t-butylpenyl)phosphite, bis(2,6-di-t-butyl-4-methylpenyl)pentaerytritolphosphite, bis(2,4-di-t-butylpenyl)pentaerytritolphosphite and the like. The addition amount of antioxidant is preferably is 0.05 to 5.0 parts by mass with respect to 100 parts by mass of the cyclic olefin-based addition polymer.

(Ultraviolet Absorber)

For the purpose of prevention of deterioration of the polarizing plate or liquid crystals, an ultraviolet absorber is preferably used for the base film of the cyclic olefin-based addition polymer. It is preferable that the ultraviolet absorber has high ability to absorb an ultraviolet ray having a wavelength of less than 370 nm and low ability to absorb a visible ray having a wavelength of more than 400 nm from a standpoint of liquid crystal display performance. An example of the ultraviolet absorber used preferably in the invention may include a hindered phenol-based compound, an oxybenzophenone-based compound, benzotriazole-based compound, a salicylic acid ester-based compound, benzophenone-based compound, a cyanoacrylate-based compound, a nickel complex-based compound, etc. Examples of the hindered phenol-based compound may include 2,6-di-tert-butyl-p-crezole, pentaerytrityltetrakis[3-(3,5-di-tert-butyl-4-hydroxypenyl)propionate], N,N′-hexamethylenebis(3,5-di-tert-butyl-4-hydroxy-hydrocinamide), 1,3,5-trimethyl-2,4,6-tris(3,5-di-tert-butyl-4-hydroxybenzyl)benzene, tris(3,5-di-tert-butyl-4-hydroxybenzyl)-isocyanurate, etc. Examples of the benzotriazole-based compound may include 2-(2′-hydroxy-5′-methylpenyl)benzotriazole, 2,2-methylenebis(4-(1,1,3,3-tetramethylbutyl)-6-(2H-benzotriazole-2-yl)phenol), (2,4-bis-(n-oxtylthio)-6-(4-hydroxy-3,5-di-tert-butylanilino)-1,3,5-triazine, triethyleneglycol-bis[3-(3-tert-butyl-5-methyl-4-hydroxypenyl)propionate], N,N′-hexamethylenebis(3,5-di-tert-butyl-4-hydroxyhydrocinamide), 1,3,5-trimethyl-2,4,6-tris(3,5-di-tert-butyl-4-hydroxybenzyl)benzene, 2(2′-hydroxy-3′,5′-di-tert-butylpenyl)-5-chlorobenzotriazole, (2(2′-hydroxy-3′,5′-di-tert-amilpenyl)-5-chlorobenzotriazole, 2,6-di-tert-butyl-p-crezole, pentaerytrityl-tetrakis[3-(3,5-di-tert-butyl-4-hydroxypenyl)propionate], etc. The addition amount of the ultraviolet absorber is preferably 1 ppm to 1.0%, more preferably 10 to 1000 ppm in mass ratio with respect to the cyclic olefin-based addition polymer.

(Matting Agent)

In the invention, it is preferable to add particles (matting agent) in order to prevent a scratch from occurring or prevent transferability from being deteriorated when the manufactured base film of the cyclic olefin-based addition polymer is handled. An example of the matting agent may include, preferably, inorganic compounds such as a silicon-containing compound, silicon dioxide, titanium oxide, zinc oxide, aluminum oxide, barium oxide, zirconium oxide, strontium oxide, antimony oxide, tin oxide, tin antimony oxide, calcium carbonate, talc, clay, fired calcium silicate, hydrated calcium silicate, aluminum silicate, magnesium silicate, calcium phosphate, or the like. Among them, the matting agent is more preferably the silicon-containing inorganic compound or the zirconium oxide, particularly preferably the silicon dioxide since it can reduce turbidity of the film. An example of particles of the silicon dioxide may include Aerosil R972, R974, R812, 200, 300, R202, OX50, Tr600 and the like (available from NIPPON AEROSIL CO., LTD.). An example of particles of the silicon dioxide may include Aerosil R972, R974, R812, 200, 300, R202, OX50, Tr600 and the like (available from NIPPON AEROSIL CO., LTD.).

The primary average particle diameter of such a matting agent is preferably from 1 nm to 20 μm, more preferably from 1 nm to 10 μm, even more preferably from 2 nm to 1 μm, and particularly preferably from 5 nm to 0.5 μm in order to suppress the haze to a low level. The primary average particle diameter of the matting agent can be measured using a transmission electron microscope. Purchased particles are often aggregated, and it is preferable to diffuse such purchased particles by a known method before use. The particles are diffused so that the secondary average particle diameter is preferably 0.1 to 1.5 μm, more preferably 0.2 to 1.0 μm. The amount of the matting agent to be incorporated in the cyclic olefin-based addition polymer is preferably 0.01 to 0.3 mass %, more preferably 0.05 to 0.15 mass %, even more preferably 0.08 to 0.08 mass %.

The range of the haze of the cyclic polyolefin film added with the particles is preferably less than 2.0%, more preferably less than 1.2%, even more particularly less than 0.5%. A dynamic friction coefficient of the cyclic polyolefin film added with the particles is preferably less than 0.8, particularly preferably less than 0.5.

The dynamic friction coefficient may be measured using a steel ball according to a method specified by JIS or ASTM. The haze may be measured using a 1001DP type haze meter (available from Nippon Denshoku Industries Co., Ltd.).

(Peeling Agent)

When the cyclic olefin-based addition polymer film is peeled from an endless metal support, a surfactant may be added in a dope, if necessary, in order to decrease a peeling load (peeling resistance) and prevent the film from being irregularly stretched in a film formation direction.

A surfactant preferably used to decrease the peeling resistance of the cyclic olefin-based addition polymer film may include, for example, an ester phosphate-based surfactant, a carboxylic acid or carboxylic acid salt-based surfactant, a sulfonic acid or sulfonic acid salt-based surfactant, an ester sulfuric acid-based surfactant, etc.

RZ-1 C₈H₁₇O—P(═O)—(OH)₂

RZ-2 C₁₂H₂₅O—P(═O)—(OK)₂

RZ-3 C₁₂H₂₅OCH₂CH₂O—P(═O)—(OK)₂

RZ-4 C₁₅H₃₁(OCH₂CH₂)₅O—P(═O)—(OK)₂

RZ-5 {C₁₂H₂₅O(CH₂CH₂O)₅}₂—P(═O)—OH

RZ-6 {C₁₈H₃₅(OCH₂CH₂)₈O}₂—P(═O)—ONH₄

RZ-7 (t-C₄H₉)₃—C₆H₂—OCH₂CH₂O—P(═O)—(OK)₂

RZ-8 (iso-C₉H₁₉—C₆H₄—O—(CH₂CH₂O)₅—P(═O)—(OK)(OH)

RZ-9 C₁₂H₂₅SO₃Na

RZ-10 C₁₂H₂₅OSO₃Na

RZ-11 C₁₇H₃₃COOH

RZ-12 C₁₇H₃₃COOH—N(CH₂CH₂OH)₃

RZ-13 iso-C₈H₁₇—C₆H₄—O—(CH₂CH₂O)₃—(CH₂)₂SO₃Na

RZ-14 (iso-C₉H₁₉)₂—C₆H₃—O—(CH₂CH₂O)₃—(CH₂)₄SO₃Na

RZ-15 triisopropylnaphthalene sulfonic acid sodium

RZ-16 tri-t-butylnaphthalene sulfonic acid sodium

RZ-17 C₁₇H₃₃CON(CH₃)CH₂CH₂SO₃Na

RZ-18 C₁₂H₂₅—C₆H₄SO₃NH₄

The addition amount of the surfactant is preferably 0.005 to 5 mass %, more preferably 0.01 to 2 mass %, most preferably 0.05 to 0.5 mass % with respect to the cyclic polyolefin.

A polymer having fluorine atoms, such as a polymer of a monomer such as acrylate or methacrylate having a perfluoroalkyl group, may be preferably used as the surfactant preferably used to decrease the peeling resistance of the cyclic olefin-based addition polymer film. The polymer having fluorine atoms, as a peeling agent (also referred to as a fluorine-containing polymer of the invention), will be hereinafter described. An example of the fluorine-containing polymer of the invention may include a polymer as disclosed in JP-A-2001-269564. A polymer obtained by polymerizing a monomer containing a fluorinated alkyl group-containing ethylenically unsaturated monomer (monomer A) as an essential component is preferably used as the polymer having fluorine atoms. The fluorinated alkyl group-containing ethylenically unsaturated monomer (monomer A) related to the polymer is not particularly limited as long as it is a compound containing an ethylenically unsaturated group and a fluorinated alkyl group in molecules. The monomer A preferably contains an acryl ester group and its affinitive group, specifically, fluorinated (mat)acrylate expressed by the following formula (III). Here, (mat)acrylate refers generally to methacrylate, acrylate, fluoroacrylate and chlorinated acrylate.
CH₂═C(R¹)—COO—(X)ₙ—Rf Formula (III)

In the formula (III), Rf represents a perfluoro alkyl group having 1 to 20 carbon atoms, or a partially fluorinated alkyl group. Rf may be a straight-chain or a branch, and may have a functional group, which contains oxygen atoms and/or nitrogen atoms, in its main chain. R¹ represents H, a fluorinated alkyl group, Cl or F, X represents a bivalent connecting group, and n represents an integer of more than 0.

The number of carbon atoms in the perfluoroalkyl group of Rf is preferably 1 to 18, more preferably 4 to 18, even more preferably 6 to 14, most preferably 6 to 12. The partially fluorinated alkyl group has preferably a perfluoroalkyl group partially. The number of carbon atoms in the perfluoroalkyl group is preferably same as the above-mentioned range. In addition, an example of the functional group containing the oxygen atoms in the main chain may include —SO₂—, —C(═O)—, etc., and an example of the functional group containing the nitrogen atoms in the main chain may include —NH—, —N(CH₃)—, —N(C₂H₅)—, —N(C₃H₇)—, etc.

The fluorinated alkyl group for R¹ may be any of a non-substituted alkyl group, a perfluoroalkyl group and a partially fluorinated alkyl group. Preferably, the fluorinated alkyl group for R¹ is the non-substituted alkyl group or the partially fluorinated alkyl group. A methyl group is preferable as the non-substituted alkyl group.

The bivalent connecting group for X may be preferably any of —(CH₂)ₘ—, —CH₂CH(OH)—(CH₂)ₘ—, —(CH₂)ₘN(R²)—SO₂—, —(CH₂)ₘN(R²)—CO—, —CH(CH₃)—, —CH(CH₂CH₃)—, —C(CH₃)₂—, —CH(CF₃)—, —C(CH₃)(CF₃)—, and —C(CF₃)₂—. Here, R² is hydrogen or an alkyl group having 1 to 6 carbon atoms.

n is an integer of more than 0, preferably 0 to 25, more preferably 1 to 15, even more preferably 1 to 10. If n is more than 2, connecting groups represented by X may be same or different.

Hereinafter, the fluorinated alkyl group-containing (mat)acrylate will be exemplified without any limitation.

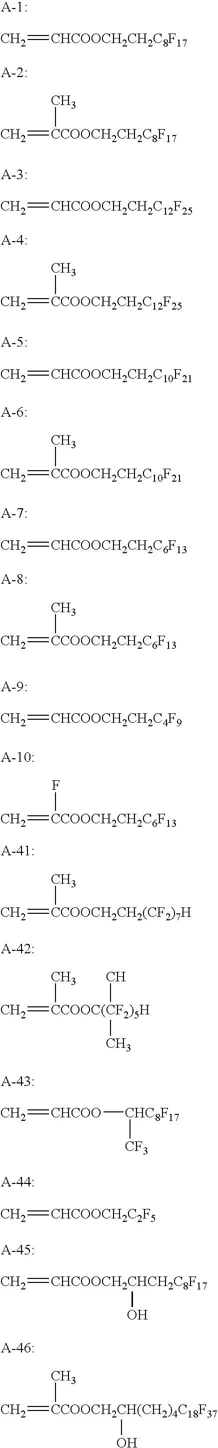

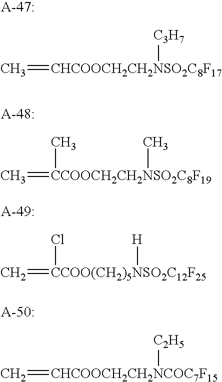

The fluorinated alkyl group-containing ethylenically unsaturated monomer (monomer A) may be used with one kind or in combination of two or more kinds. A fluorinated alkyl group in the fluorinated alkyl group-containing ethylenically unsaturated monomer (monomer A) has preferably 6 to 18 carbon atoms, more preferably 6 to 14, particularly preferably 6 to 12 from a standpoint of releasing property (peeling property). In the invention, the amount of the fluorinated alkyl group-containing ethylenically unsaturated monomer (monomer A) to be introduced in a polymer having fluorine atoms is not particularly limited, but may be preferably more than 10 mass %, more preferably more than 15 mass %, even more preferably more than 20 mass % for polymerization.

In addition, in the invention, a polyoxyalkylene group-containing unsaturated monomer (monomer B) may be contained in the polymer having the fluorine atoms. The polyoxyalkylene group-containing unsaturated monomer (monomer B) is not particularly limited as long as it is a compound containing a polyoxyalkylene group or an ethylenically unsaturated group in one molecule. The polyoxyalkylene group is preferably an ethylene oxide and/or a propylene oxide group and has the degree of polymerization of 1 to 100, preferably 5 to 50. The ethylenically unsaturated group preferably contains a (mat)acryl ester group and its affinitive group from the standpoint of availability of raw materials, solubility of mixture in various coating compositions, controllability of such solubility, or polymerization reactivity. The number of unsaturated bonds may be one or two or more in one molecule.

(Organic Solvent)

Next, an organic solvent in which the cyclic polyolefin of the invention is dissolved will be described. In the invention, the organic solvent is not particularly limited as long as it can dissolve the cyclic polyolefin so that the cyclic polyolefin can be flow-cast and used to form a film. The organic solvent used in the invention may include, for example, chlorine-based solvent such as dichloromethane or chloroform, aliphatic hydrocarbon, cyclic hydrocarbon, aromatic hydrocarbon, ester, ketone or ether, each of which has 3 to 12 carbon atoms. Ester, ketone and ether each may each a cyclic structure. An example of the aliphatic hydrocarbon having 3 to 12 carbon atoms may include hexane, octane, isooctane, decane, etc. An example of the cyclic hydrocarbon having 3 to 12 carbon atoms may include cyclopenpane, cyclohexane, and derivatives thereof. An example of the aromatic hydrocarbon having 3 to 12 carbon atoms may include benzene, toluene, xylene, etc. An example of the esters having 3 to 12 carbon atoms may include ethylformate, propylformate, pentylformate, methylacetate, ethylacetate and pentylacetate. An example of the ketones having 3 to 12 carbon atoms may include acetone, methylethylketone, diethylketone, diisobutylketone, cyclopentanone, cyclohexanone and methylcyclohexanone. An example of the ethers having 3 to 12 carbon atoms may include diisopropylether, dimethoxymethane, dimethoxyethane, 1,4-dioxane, 1,3-dioxorane, tetrahydrofurane, anisole and phenetole. An example of an organic solvent having two or more kinds of functional groups may include 2-ethoxyethylacetate, 2-methoxyethanol and 2-buthoxyethanol. The boiling point of the organic solvent is preferably more than 35° C. and less than 110° C.

Non-chlorine-based organic solvents have been conventionally used for solution formation of the cyclic polyolefin, as disclosed in, for example, JP-A-8-43812, JP-A-2001-272534 and JP-A-2003-306557. In a dry process, a non-chlorine-based organic solvent may be charged by peeling from a pass roll, which may cause a fire to break out by a discharging. The inventors have found that a chlorine-based organic solvent could be particularly preferably used as a main solvent to produce a cyclic polyolefin solution. A chlorine-based organic solvent is very advantageous in industrial use because of its high solubility and no or little flammability. In addition, the inventors have found that it was ease to improve release ability of a film, as will be described later. In the invention, the chlorine-based organic solvent is not particularly limited in the kind as long as it can dissolve the cyclic polyolefin so that the cyclic polyolefin can be flow-cast and used to form a film. The chlorine-based organic solvent is preferably dichloromethane or chloroform. In particular, dichloromethane is more preferable since it has a low boiling point, thereby providing high heat efficiency in a dry process. Organic solvents, e.g., the aforementioned organic solvents, other than the chlorine-based organic solvent may be also mixed with the chlorine-based organic solvent without any problem. In this case, the amount of the chlorine-based organic solvent is preferably 50 to 99.5 mass % for the total amount of mixture of solvent. The amount of dichloromethane is preferably at least 50 mass % for the total amount of mixture of solvent. The non-chlorine-based organic solvent preferably used in combination with the chlorine-based organic solvent in the invention will be hereinafter described. The organic solvent preferably used in the invention may include, for example, ester, ketone or ether, alcohol, or hydrocarbon, each of which has 3 to 12 carbon atoms. Ester, ketone, ether and alcohol each may have a cyclic structure. A compound having two or more functional groups (that is, —O—, —CO— and —COO—) of one of ester, ketone and ether may be used as a solvent. This compound may further have a different functional group such as an alcoholic hydroxyl group. In the case of a solvent having two or more kinds of functional groups, the number of carbon atoms may be within a specified range of the number of carbon atoms of a compound having one of the kinds of functional groups. An example of the esters having 3 to 12 carbon atoms may include ethylformate, propylformate, pentylformate, methylacetate, ethylacetate and pentylacetate. An example of the ketones having 3 to 12 carbon atoms may include acetone, methylethylketone, diethylketone, diisobutylketone, cyclopentanone, cyclohexanone and methylcyclohexanone. An example of the ethers having 3 to 12 carbon atoms may include diisopropylether, dimethoxymethane, dimethoxyethane, 1,4-dioxane, 1,3-dioxorane, tetrahydrofurane, anisole and phenetole. An example of an organic solvent having two or more kinds of functional groups may include 2-ethoxyethylacetate, 2-methoxyethanol, 2-buthoxyethanol, etc.

The inventors have found that release ability could be greatly improved by dissolving cyclic polyolefin into a mixture obtained by mixing a small quantity of poor solvent having little solubility to the cyclic polyolefin with a chlorine-based solvent as a main solvent. When the poor solvent is properly mixed with the chlorine-based solvent, a peeling resistance value when a film is peeled from a metal support decreases to a range of ⅕ to 1/20 of an original peeling resistance value as compared when a film is formed without using the poor solvent, thereby facilitating high speed film formation. The effect of reduction of the peeling resistance by use of the poor solvent is remarkable to the addition (co)polymer cyclic polyolefin.

Preferably, the poor solvent need be properly selected depending on the kind of polymer used. It is preferable that the poor solvent has a boiling point higher by more than 10° C. than that of the main solvent (solvent having high solubility) first used and has volatility lower than that of the main solvent. When the poor solvent has the boiling point higher than that of the main solvent, it is believed that the amount of solvent remaining in the film depends on the amount of the poor solvent when the film is dried to be peeled from the metal support. Among poor solvents for the cyclic polyolefin, univalent alcohol is particularly preferable since it shows a great effect of reduction of peeling resistance. Although the particularly preferable alcohol is varied depending on the boiling point of the solvent having high solubility, considering a dry load, alcohol having a boiling point of less than 120° C. is preferable, univalent alcohol having 1 to 6 carbon atoms is more preferable, and alcohol having 1 to 4 carbon atoms is even more preferable.

In addition, alcohol used in combination with the chlorine-based organic solvent may have preferably a straight chain or a branch, or may be cyclic. Preferably, this alcohol is saturated alicyclic hydrocarbon. A hydroxyl group of the alcohol may be first, secondary or tertiary. An example of the alcohol may include methanol, ethanol, 1-propanol, 2-propanol, 1-butanol, 2-butanol, t-butanol, 1-pentanol, 2-methyl-2-butanol, and cyclohexane. Further, the alcohol in the invention may include fluorine-based alcohol, for example, 2-fluoroethanol, 2,2,2-trifluoroethanol, 2,2,3,3-tetrafluoro-1-propanol, etc.

A mixture solvent particularly preferably used to prepare a cyclic polyolefin solution is a combination of dichloromethane as the main solvent and one or more kinds of alcohols selected from methanol, ethanol, propanol and isopropane as the poor solvent.

The content of alcohol poor solvent is preferably 3 to 100 parts by mass, more preferably 4 to 40 parts by mass, even more preferably 6 to 35 parts by mass for 100 parts by mass of the cyclic polyolefin. The mixture ratio of the poor solvent to the main solvent is preferably 0.5 to 30 parts by mass, more preferably 1 to 20 parts by mass, even more preferably 4 to 15 parts by mass.

<Formation of Base Film Using Solution Film Formation Method>

The formation of a film from the cyclic olefin-based addition polymer of the invention can be carried out by either heat fusion film formation method or solution film formation method. Firstly, the solution film formation method will be described.

(Dope Preparation)

Next, the cyclic polyolefin solution (dope) of the invention is prepared by a room temperature stirring dissolution method, a cooling dissolution method of stirring and swelling a polymer at a room temperature, cooling it to −20 to −100° C., and then heating it to 20 to 100° C. for dissolution, a high temperature dissolution method of dissolving a polymer in an airtight container at a temperature higher than the boiling point of a main solvent, or a method of dissolving a polymer at a high temperature and high pressure up to the critical point of solvent. A polymer having good solubility is preferably dissolved at the room temperature, whereas a polymer having poor solubility is heated and dissolved in the airtight container. When dichloromethane is selected as the main solvent, most of the cyclic polyolefin can be dissolved by being heated at 20 to 100° C. It is convenient for process that a polymer having not too poor solubility is dissolved at a temperature as low as possible.

Viscosity of the cyclic polyolefin solution is preferably 1 to 500 Pa·s, more preferably 5 to 200 Pa·s at 25° C. The viscosity is measured as follows. A sample solution of 1 ml was measured using steel cone of a diameter 4 cm/2° as Rheometer (CLS 500) (both being produced by TAXAS Instruments Inc.).

The sample solution was measured after reaching a predetermined measurement start temperature.

The cyclic polyolefin solution can be used to obtain a high-concentrated dope, and it is possible to obtain a high-concentrated cyclic polyolefin solution having high stabilization without using separate condensation means. The cyclic polyolefin may be dissolved at a low temperature for easer dissolution and then condensed using condensation means. A condensation method is not particularly limited, but may include, for example, a method of leading a low-density solution between a cylinder body and a rotary locus of an outer circumference of a rotary blade tuning in a circumferential direction of the inside of the cylinder body and obtaining a high-density solution while evaporating a solvent by giving a temperature difference between the low-density solution and the cylinder body (for example, see JP-A-4-259511, etc.), a method of spraying a hot low-density solution from a nozzle into a container, evaporating a solvent until the solution from the nozzle reaches an inner wall of the container, drawing the evaporated solvent out of the container, and drawing a high-density solution out of the bottom of the container (for example, see U.S. Pat. Nos. 2,541,012, 2,858,229, 4,414,341, 4,504,355, etc.), etc.

It is preferable that the solution is filtered through a proper filtering material such as a wire net or a flannel to remove indissoluble products or alien substances, such as dusts and impurities, prior to flow casting. A filter with absolute filter precision of 0.1 to 100 μm, preferably 0.5 to 25 μm, is used for the filtration of the cyclic polyolefin solution. Thickness of the filter is preferably 0.1 to 10 mm, more preferably 0.2 to 2 mm. In this case, a filtration pressure is less than 1.6 Mpa, preferably less than 1.3 Mpa, more preferably less than 1.0 Mpa, even more preferably less than 0.6 Mpa. Preferably, the filtering material may include, for example, glass fiber, cellulose fiber, filer paper, fluororesin such as tetrafluorethylene resin, which are known in the art, ceramics, metal, etc.

Viscosity of the cyclic polyolefin solution immediately before film formation is preferably 5 Pa·s to 1000 Pa·s, more preferably 15 Pa·s to 500 Pa·s, even more preferably 30 Pa·s to 200 Pa·s in a flow-castable range for film formation. The temperature at this point is not particularly limited if only it is a temperature for flow casting of film, but may be preferably −5 to 70° C., more preferably −5 to 35° C.

(Film Formation)

A method of forming a film using the cyclic polyolefin solution will be hereinafter described. A cyclic polyolefin film of the invention is manufactured using a solution flow casting film formation method and a solution flow casting film formation apparatus, which are similar to those used for manufacture of cellulose acetate film in the related art. A dope (cyclic polyolefin solution) prepared in a furnace is stored in a storage pot, and then bubbles are removed from the dope. The dope is sent to a pressing die from a dope outlet through a pressing metering gear pump which can send out the dope by a controlled amount with high precision depending on the number of rotations. Then, the dope is uniformly flow-cast on an endless metal support of a flow casting portion running endlessly from slits of the pressing die, and a dope film (also referred to as web) which is half-dried at a peeling point around which the metal support makes about one trip is peeled from the metal support. With both ends of the obtained web clipped, the web is conveyed to a tenter in which the web is dried. Subsequently, the dried web is conveyed to a group of rolls of a drier to dry the web again, and then is wound in a predetermined length by a winding machine. A combination of the tenter and the drier having the group of rolls is varied depending on its use purpose. For the solution flow casting film formation used to form a functional protective film for electronic display, in addition to the solution flow casting film formation apparatus, in many cases, a coating device is added to process surfaces of films such as a undercoat layer, an antistatic layer, an antihalation layer, a protective layer and the like. Various manufacturing processes will be hereinafter described in brief without being limited thereto.

First, when the cyclic polyolefin film is manufactured by a solvent cast method, it is preferable that the prepared cyclic polyolefin solution (dope) is flow-cast over, for example, a metal drum or a metal support (band or belt) and a solvent is evaporated to form the film. It is preferable that dope before being flow-cast is adjusted in concentration so that the amount of cyclic polyolefin becomes 10 to 35 mass %. It is preferable that a surface of the drum or band is finished to a mirror state. The dope is preferably flow-cast over the drum or band having a surface temperature of less than 30° C., more preferably over the metal support having a surface temperature of −10 to 20° C.

Cellulose acylate film formation techniques disclosed in JP-A-2000-301555, JP-A-2000-301558, JP-A-7-032391, JP-A-3-193316, JP-A-5-086212, JP-A-62-037113, JP-A-2-276607, JP-A-55-014201, JP-A-2-111511 and JP-A-2-208650 are applicable to the invention.

(Flow Casting of Multi-Layer)

The cyclic polyolefin solution may be flow-cast as either a single layer solution or a multi layer solution over a smooth band or drum as the metal support.

When the cyclic polyolefin solution is flow-cast as the multi-layer solution, the film may be manufactured while flow-casting and laminating solutions containing the cyclic polyolefin, which are discharged from a plurality of flow casting holes provided with predetermined intervals in a traveling direction of the metal support, or may be manufactured using methods disclosed in, for example, JP-A-61-158414, JP-A-1-122419, JP-A-1′-198285, etc.

In addition, the film may be formed by stretching cyclic polyolefin solutions which are discharged from two flow casting holes, or may be formed using methods disclosed in, for example, JP-A-60-27562, JP-A-61-94724, JP-A-61-947245, JP-A-61-104813, JP-A-61-158413, JP-A-6-134933, etc. In addition, the film may be formed using a cyclic polyolefin film flow casting method of surrounding a high-viscous cyclic polyolefin solution with a low-viscous cyclic polyolefin solution and extruding the high and low-viscous cyclic polyolefin solutions simultaneously, as disclosed in JP-A-56-162617. In addition, the film may be preferably formed using a technique in which an outer solution contains an alcohol component as a poor solvent more than an inner solution, as disclosed in JP-A-61-94724 and JP-A-61-94725. Alternatively, the film may be formed using a method of using a first flow casting hole to peel off a film formed on a metal support and using a second flow casting hole to flow-cast a film at a side contacting the metal support, as disclosed in, for example, JP-A-44-20235. Cyclic polyolefin solutions to be flow-cast may be either same or different without any limitation. In order to provide a plurality of cyclic polyolefin layers with respective functionalities, cyclic polyolefin solutions meeting the respective functionalities may be extruded from respective flow casting holes. The cyclic polyolefin solutions may be simultaneously flow-cast for various different functional layers (for example, an adhesive layer, a dye layer, an antistatic layer, an antihalation layer, an UV absorbing layer, a polarizing layer, etc.)

For the single layer solution, in order to form a film at a required thickness, it is necessary to extrude a high-concentrated and high-viscous cyclic polyolefin solution. In this case, stability of the cyclic polyolefin solution becomes worsen, which may result in occurrence of solids, projection trouble, and bad planarization. For the purpose of overcoming this problem, by flow-casting a plurality of high-viscous cyclic polyolefin solutions from flow casting holes, the solutions can be simultaneously extruded on a metal support, which results in good planarization, thereby making it possible to manufacture a flat film. In addition to this, by using high-concentrated cyclic polyolefin solutions, it is possible to reduce a dry load and increase productivity of films.

In the case of multi-flow casting, thickness of inner and outer layers is not particularly limited, but the thickness of the outer layer is preferably 1 to 50%, more preferably 2 to 30% of the total film thickness. In the case of multi-flow casting for more than 3 layers, the sum of film thickness of a layer contacting a metal support and film thickness of a layer contacting air is defined as outer thickness. In the case of multi-flow casting, a cyclic polyolefin film having a multi-layered structure may be formed by multi-flow casting cyclic polyolefin solutions that contain additives, such as the aforementioned deterioration protective agent, the ultraviolet absorber, the matting agent and the like, which are different in concentration. For example, a having cyclic polyolefin film having a structure of skin layer/core layer/skin layer may be formed. For example, the matting agent may be contained much in the skin layers or only in the skin layers. Also, the deterioration protective agent and the ultraviolet absorber may be contained more in the core layer than in the skin layer or only in the core layer. In addition, the kind of the deterioration protective agent and the ultraviolet absorber in the core layer and the skin layers may be varied. For example, a low-volatile deterioration protective agent and/or a low-volatile ultraviolet absorber may be contained in the skin layers, and a plasticizer having high plasticity or an ultraviolet absorber having ultraviolet ray absorptiveness may be added in the core layer. In addition, in order to gel a solution by cooling a metal support using a cooling drum method, it is preferable that alcohol as a poor solvent is added more in the core layer than in the skin layers. Glass transition temperature (Tg) of the core layer may be different from, preferably lower than that of the skin layers. In addition, in flow casting, viscosity of a cyclic polyolefin-containing solution in the skin layers may be different from that of the core layer. The viscosity in the skin layers is preferably lower than that in the core layer, but the viscosity in the core layer may be lower than that in the skin layers.

(Flow Casting)

A solution flow casting method may include, for example, a method of uniformly extruding a prepared dope on a metal support from a pressing die, a method using a doctor blade for adjusting film thickness of a dope, which is flow-cast on a metal support, with a blade, a method using a reverse roll coater for adjusting film thickness of a dope with a reversely rotating roll, etc. Among these methods, the method using the pressing die is most preferable. A pressing die may include, for example, a coat hanger type, a T die type, etc., both of which are preferably used in the invention. In addition to the aforementioned methods, other methods may be used to flow-cast a cellulose triacetate solution for film formation known in the art. By setting conditions in consideration of a difference in boiling point and so on between the solution and a solvent, the same effects as those described in their respective publications can be obtained. A drum whose surface is mirror-finished by chrome plating or a stainless belt (also referred to as a band) whose surface is mirror-finished by surface polishing is used as the endlessly running metal support used to manufacture the cyclic polyolefin film of the invention. The number of pressing dies used to manufacture the cyclic polyolefin film of the invention and installed over the metal support is one or two or more, preferably one or two. In the case where two or more pressing dies are installed, the amount of dope to be flow-cast may be divided with different ratios for respective dies, and dope may be sent to respective dies with respective ratios from a plurality of precise metering gear pumps. Temperature of the cyclic polyolefin solution for flow casting is preferably −10 to 55° C., more preferably 25 to 50° C. In this case, all processes may be same, or some of processes may be different from others of processes. In the latter, the temperature for flow casting may be temperature desired immediately before flow casing.

(Dry)

A method of drying the dope on the metal support, which is concerned with manufacture of the cyclic polyolefin film, may include, for example, a method of blowing hot wind from a surface of a metal support (for example, drum or band), that is, a surface of a web on the metal support, a method of blowing hot wind from a rear side of a drum or a band, a method of contacting temperature-controlled liquid from a rear side of a band or a drum, which is in the opposite side of a dope flow cast plane, and controlling a surface temperature of the band or the drum by heating the drum or the band through heat transmission, etc. Among these methods, the rear side liquid heat transmission method is more preferable. As long as the surface temperature of the metal support before flow casting is less than the boiling point of a solvent used for the dope, the metal support may have any surface temperature. However, in order to accelerate dry of the dope and remove fluidity of the dope on the metal support, it is preferable to set the surface temperature of the metal support to be lower by 1 to 10° C. than the boiling point of a solvent, which is the lowest of boiling points of solvents used, except when a flow cast dope is cooled and peeled without being dried.

(Peeling)

When a half-dried film is peeled from the metal support, if peeling resistance (peeling load) is large, the film may be irregularly extended in a film formation direction, thereby causing optically anisotropic stains. In particular, when the peeling load is large, the film may have a stepped shape in which extended sites and non-extended site are alternating, thereby causing a retardation distribution. When the film is loaded in a liquid crystal display device, line or belt-shaped stains may be shown up. In order to prevent such a problem, the peeling load of the film is preferably less than 0.25 N, more preferably less than 0.2 N, even more preferably less than 0.15 N, particularly preferably less than 0.10 N per film peeling width of 1 cm. When the peeling load is less than 0.2 N/cm, it is particularly advantageous in that even a liquid crystal display device which is likely to show stains shows no stains due to peeling. A method of making the peeling load small may include, for example, a method of adding the peeling agent as described above and a method of selection of composition of a solvent used.

The peeling load is measured as follows. A dope is dropped on a metal plate having the same material and surface roughness as the metal support of the film formation apparatus, and then the dope is stretched at a uniform thickness using a doctor blade and is dried to form a film. The resultant film is inscribed in a stripe shape at equal intervals using a cutter knife. Then, a leading edge of the film is peeled off by hand, and, with the film fixed by a clip connected to a strain gauge, change of load of the film is measured while pulling up the strain gauge with an inclination of 45° C. The amount of volatile component in the peeled film is also measured. The same measurement is repeated several times while changing dry time, and a peeling load when the amount of volatile component is equal to the amount of remaining volatile component in peeling of the film in an actual film formation process. As a peeling speed increases, the peeling load tends to increase, and thus, it is preferable to measure the film at a peeling speed close to an actual peeling speed.

Concentration of the remaining volatile component in peeling of the film is preferably 5 to 60 mass %, more preferably 10 to 50 mass %, even more preferably 20 to 40 mass %. When the film is peeled with a high degree of volatility, it is advantageous in that dry speed can increase, thereby improving productivity. On the other hand, when the film is peeled with the high degree of volatility, the film has strength or elasticity of the film becomes small, its peeling force becomes insufficient, and deformation, creases and knick are likely to occur in the film.

(Stretching Treatment)

It is preferable to subjecting the cyclic polyolefin film of the invention to a stretching treatment in the state where a solvent sufficiently remains in the film immediately after peeling of the film. The aim of the stretching treatment is (1) to obtain a film having excellent planarization without creases and deformation and (2) to make in-plane retardation of the film large. To achieve the aim (1), the film is stretched at a relatively high temperature and with a low stretching ratio of 1 to 10%, preferably 2 to 5%. To achieve both of the aims (1) and (2) or only the aim (2), the film is stretched at a relatively low temperature and with a stretching ratio of 5 to 150%.

Next, selection of stretch temperature will be described. The film containing the remaining solvent is put in an airtight fan, and specific heat of the film is measured. The temperature at which a temperature-to-heat curve is inflected and the specific heat begins to lower is assumed to be Tc. The relatively high stretch temperature refers to a temperature higher by more than 10° C., preferably more than 15 to 30° C., than Tc. Even when the cyclic polyolefin film is stretched at this relatively high stretch temperature, the film shows little retardation.

On the other hand, the relatively low stretch temperature refers to a temperature falling within a range of 10° C. before and after Tc. When the film is stretched in this temperature range, the film is likely to show in-plane retardation and is apt to be adjusted to a desired optical characteristic.

When the film is stretched while a solvent remains in the film, the film can be stretched at a lower temperature than a dried film. Although there are many polymers having a high glass transition point (Tg), the cyclic polyolefin can be stretched at a temperature lower than the high glass transition point (Tg) of the polymers.

The stretch of the film may be either uniaxial stretch in one of vertical and horizontal directions or simultaneous or sequential biaxial stretch in both of vertical and horizontal directions. For birefringence of a phase difference film for a VA liquid crystal cell or an OCB liquid crystal cell, it is preferable that the birefringence in a width direction becomes larger than that in a length direction. Accordingly, it is preferable to stretch the film more in the width direction than in the length direction.

(Post-Drying)

The stretched cyclic polyolefin film is further dried so that the amount of remaining volatile component is less than 2%, and then is wound up. It is preferable to knurl both ends of the film before winding the film. Knurling width is 3 to 50 mm, preferably 5 to 30 mm, and knurling height is 1 to 50 μm, preferably 2 to 20 μm, more preferably 3 to 10 μm. This may be either single press or double press.

Thickness of the completed (dried) cyclic polyolefin film of the invention is typically 5 to 500 μm, preferably 30 to 150 μm, particularly preferably 40 to 110 μm for a liquid crystal display device, depending on use purpose of the film.

The film thickness may be adjusted by controlling concentration of solids contained in the dope, slit gap of die, extrusion pressure from die, speed of the metal support, etc. The width of the cyclic polyolefin film thus obtained is preferably 0.5 to 3 m, more preferably 0.6 to 2.5 m, even more preferably 0.8 to 2.2 m. The winding length per one roll is preferably 100 to 10000 m, more preferably 500 to 7000 m, even more preferably 1000 to 6000 m. When the film is wound up, it is preferable to knurl at least one end of the film. Knurling width is 3 to 50 mm, preferably 5 to 30 mm, and knurling height is 0.5 to 500 μm, preferably 1 to 200 μm. This may be either single press or double press. Deviation of Re value of the total width is preferably ±5 nm, more preferably ±3 nm. In addition, Deviation of Rth value is preferably ±10 nm, more preferably ±5 nm. In addition, it is preferable that deviations of Re and Rth values in the length direction fall within a range of deviation in the width direction. In order to maintain transparency, haze is preferably 0.01 to 2%. In order to make the haze small, the number of agglomerated particles becomes small by sufficiently dispersing an added corpuscle matting agent, or the matting agent is used only for the skin layers for less use of the matting agent.

<Formation of Base Film Using Heat Fusion Film Formation Method>

The heat fusion film formation method will be further described hereinafter. The heat fusion film formation method involves a step of extruding a molten cyclic olefin-based addition polymer through the die of an extruder to form a sheet which is then cooled on a cold roll to form a base film of cyclic olefin-based addition polymer.

In this production method, in the case where the cyclic olefin-based addition polymer is melted, the pelletized cyclic olefin-based addition polymer may be preheated. The preheating temperature is from (Tg−90° C.) to (Tg+15° C.), preferably from (Tg−75° C.) to (Tg−5° C.), even more preferably from (Tg−70° C.) to (Tg−5° C.). When the cyclic olefin-based addition polymer is preheated to a range of from (Tg−90° C.) to (Tg+15° C.), the subsequent melt kneading of the resin can be uniformly conducted, making it possible to obtain desired H-V scattered light intensity and V-V scattered light intensity values.

In the aforementioned production method, the cyclic olefin-based addition polymer which has been preheated is then heated to a temperature of from 200° C. to 300° C. using an extruder so that it is melted. During this procedure, the temperature of the outlet side of the extruder is preferably from 5° C. to 100° C., more preferably from 20° C. to 90° C., even more preferably from 30° C. to 80° C. higher than that of the inlet side of the extruder. By predetermining the temperature of the outlet side of the extruder higher than that of the inlet side of the extruder, the molten resin can be uniformly kneaded, making it possible to obtain desired H-V scattered light intensity and V-V scattered light intensity values.

In the aforementioned production method, the molten cyclic olefin-based addition polymer is passed through a gear pump. After the removal of pulsation from the extruder, the molten cyclic olefin-based addition polymer is filtered through a metallic mesh filter, and then extruded through a T-shaped die attached to the extruder onto a cold roll to form a sheet. The cyclic olefin-based addition polymer film thus formed on the cold roll is then pressed on the area ranging from the edge thereof to 1 to 50%, preferably 2 to 40%, more preferably 3 to 30% of the width thereof. Preferably, the film is pressed uniformly beginning with the both edges thereof to 1 to 50% of the width.

When the film thus extruded is pressed on the entire surface of the cold roll as in the related art, local cooling unevenness due to extrusion unevenness or temperature unevenness on the cold roll occurs. Such an uneven shrinkage stress cannot be released from the film because the film is entirely pressed. When the film thus extruded is entirely pressed against the cold roll, the temperature of the film rapidly falls, possibly causing the occurrence of Re unevenness and Rth unevenness, particularly Rth unevenness. On the contrary, when the film thus extruded is pressed in the aforementioned manner according to the invention, uneven shrinkage stress in the base film of cyclic olefin-based addition polymer can be avoided, making it possible to fairly inhibit the occurrence of Re unevenness and Rth unevenness.

The pressing method in the production method of the invention is not specifically limited. For example, a method using air chamber, vacuum nozzle, electrostatic pinning, touch roll or the like may be employed. The pressure at which pressing is conducted is not specifically limited but is preferably from 0.001 to 20 kg/cm² (98 Pa to 1.96 MPa), more preferably from 0.01 to 1 kg/cm² (980 Pa to 98 kPa).

In the aforementioned production method, pressing may be conducted while cooling the film on the cold roll. During this procedure, cooling is preferably conducted as slow as possible. In ordinary film-forming methods, cooling is conducted at a rate of 50° C./sec or more. In the aforementioned production method, however, cooling is preferably conducted at a rate of from 0.2 to 20° C./sec, more preferably from 0.5 to 15° C./sec, even more preferably from 1 to 10° C./sec. When cooling is conducted at the above defined rate, the occurrence of local cooling unevenness can be prevented, making it possible to inhibit the development of shrinkage stress due to rapid shrinkage and hence the development of Re unevenness and Rth unevenness.

The aforementioned cooling (slow cooling) can be attained by keeping the temperature of the cold roll in the casing constant and adjusting the temperature of the cold roll. The former can exert a desired effect.

In order to keep the temperature of the cold roll in the casing constant, at least one of the cold rolls may be disposed in a casing the temperature in which is controlled to a range of from (Tg−100° C.) to (Tg+30° C.), more preferably from (Tg−80° C.) to (Tg+10° C.), even more preferably from (Tg−70° C.) to Tg. Since the sheet thus formed is restricted by frictional force and thus cannot freely shrink on the cold roll, the resulting shrinkage stress can easily cause the occurrence of Re unevenness and Rth unevenness. However, the use of the aforementioned approach allows slow and uniform cooling along the width of the film, making it possible to reduce the temperature unevenness on the cold roll and hence Re unevenness and Rth unevenness.

On the contrary, the method disclosed in JP-A-2003-131006 involves controlling of the temperature between T-shaped die and the gap between cold rolls (air gap). In this method, however, Re unevenness and Rth unevenness cannot be sufficiently reduced. This is because the air gap has no means of restricting the film and thus exerts little effect of reducing Re unevenness and Rth unevenness.

In order to further reduce Re unevenness and Rth unevenness, the following methods may be used as well.

(1) The sheet of cyclic olefin-based addition polymer which has been extruded through the die attached to the extruder is then casted over at least 2 to 10, preferably 2 to 6, more preferably 3 to 4 cold rolls (rolls disposed close to each other) which are disposed at a constant interval. By thus controlling the cooling temperature using a plurality of cold rolls, the cooling temperature can be easily adjusted. Further, by disposing the cold rolls at a constant interval, the change of temperature between the cold rolls can be reduced.

The gap between the cold rolls (gap between the closest peripheral points of the adjacent rolls) is preferably from 0.1 to 15 cm, more preferably from 0.3 to 10 cm, even more preferably from 0.5 to 5 cm.

(2) The temperature of at least the first of 2 to 10 cold rolls is predetermined to be from (Tg of cyclic olefin-based addition polymer−40° C.), more preferably (Tg−35° C.) to (Tg−30° C.), even more preferably (Tg−30° C.) to Tg, most preferably from (Tg−30° C.) to (Tg−5° C.). Further, the temperature of the second of the cold rolls is preferably predetermined to be 1 to 30° C., more preferably 1 to 20° C., even more preferably 1 to 10° C. higher than that of the first cold roll. By thus predetermining the temperature of the second cold roll higher than that of the first cold roll, the viscosity of the cyclic olefin-based addition polymer film can be further raised, making it possible to raise the adhesion of the film to the second cold roll. In this manner, the film can be prevented from slipping over the cold roll, making it possible to inhibit the occurrence of conveying tension unevenness and reduce Re unevenness and Rth unevenness.

(3) The conveying speed of the second cold roll is predetermined to be 0.1 to 5%, preferably 0.2 to 4%, more preferably 0.3 to 3% higher than that of the first cold roll. In this arrangement, the film can be prevented from slipping between the first cold roll and the second cold roll, making it possible to inhibit the occurrence of conveying tension unevenness and reduce Re unevenness and Rth unevenness.

(4) The film which has passed over the second cold roll is then passed over a third cold roll the temperature of which is 1 to 30° C., preferably 1.5 to 20° C., more preferably 2 to 10° C. lower than that of the second cold roll. In this manner, the rate at which the film is cooled at the subsequent step of peeling the cyclic olefin-based addition polymer film off the cold roll can be lowered, making it possible to reduce Re unevenness and Rth unevenness. Further, the conveying speed of the third cold roll is predetermined to be 0.1 to 5% (preferably 0.2 to 4%, more preferably 0.3 to 3%) lower than that of the second cold roll. In this manner, the conveying tension unevenness between the second cold roll and the third cold roll can be buffered, making it possible to reduce Re unevenness and Rth unevenness.

The aforementioned production method may further involve a step of peeling the cyclic olefin-based addition polymer film off the cold roll after the aforementioned step of cooling the cyclic olefin-based addition polymer film which has thus been cooled at a rate of 0.2 to 20° C./sec.

The cyclic olefin-based addition polymer film thus peeled can be conveyed over a plurality of rolls disposed at an interval of from 0.2 to 10 m, preferably from 0.3 to 8 m, more preferably from 0.4 to 6 m. By thus conveying the film over such a long span while being cooled, the conveying tension unevenness due to friction with the conveying rolls can be suppressed. During cooling, conveying tension is ill-balanced due to ill-balanced shrinkage from left to right. In order to relax the ill-balanced conveying tension, a roll gap wide enough to allow free movement of the film and buffering is needed. When the gap between the conveying rolls is from 0.2 to 10 m, the cyclic olefin-based addition polymer film undergoes no friction with the conveying rolls and thus can freely move, making it possible to reduce the deviation of optical axis due to tension unevenness.

The cyclic olefin-based addition polymer film which has been peeled off the cold roll is preferably cooled to 50° C. at a rate of 0.1 to 3° C./sec, more preferably 0.2 to 2.5° C./sec, even more preferably 0.3 to 2° C./sec. When the cyclic olefin-based addition polymer film is cooled at a rate of 0.1 to 3° C./sec, the occurrence of deviation of optical axis due to ill-balanced tension from left to right caused by rapid shrinkage stress can be prevented. The controlling of cooling rate can be attained by passing the cyclic olefin-based addition polymer film through a casing into which air is blown such that the downstream temperature is lower than the upstream temperature. Alternatively, the controlling of cooling rate can be attained by adjusting the temperature of the upstream and downstream conveying rolls.

In the aforementioned production method, the film forming speed is preferably from 40 to 150 m/min, more preferably from 50 to 100 m/min, even more preferably from 60 to 80 m/min. When the film is formed at a speed of from 40 to 150 m/min, air can be taken into the gap between the first cold roll and the cyclic olefin-based addition polymer film, making it possible to suppress the pressure over the entire surface thereof and hence Re unevenness and Rth unevenness.

The width of the film thus formed is from 1.5 to 5 m, preferably from 1.6 to 4 m, more preferably 1.7 to 3 m. By thus predetermining the width of the film to be so great, the crosswise shrinkage stress at the conveying step following the step of peeling the cyclic olefin-based addition polymer film off the cold roll can be suppressed. In other words, if the width of the film thus formed is not so great, it is difficult to buffer the resulting tension unevenness in the crosswise direction. On the contrary, if the width of the film thus formed is so great enough, the resulting tension unevenness can be crosswise buffered, making it possible to reduce unevenness in optical axis.

(Characteristic of Base Film)

The base film of cyclic olefin-based addition polymer has a great advantage that it has a small moisture permeability and equilibrium water content as compared with cellulose acylate film which has been heretofore used in polarizing plates. The moisture permeability of the base film is preferably 1,000 g or less per m² after 24 hours of aging at 60° C. and 95% RH. The moisture permeability of the base film is more preferably 400 g or less per m² after 24 hours of aging at 60° C. and 95% RH. The equilibrium water content of the base film is preferably 2.0% or less as measured at 25° C. and 80% RH. The equilibrium water content of the base film is more preferably 1.0% or less. When the additives such as ultraviolet absorber and retardation developer are volatile or decomposable to cause the change of mass or dimension of the film, the optical characteristics of the base film undergoes change. Accordingly, the mass change of the film after 48 hours of aging at 80° C. and 90% RH is preferably 5% or less. Similarly, the dimensional change of the film after 24 hours of aging at 60° C. and 95% RH is 5% or less. Even when the film undergoes some dimensional or mass change, the film undergoes little change of optical characteristics if its photoelastic coefficient is small. Accordingly, the photoelastic coefficient of the film is preferably 30×10⁻¹³ cm²/dyne (3×10⁻¹³ N/m²) or less, more preferably 15×10⁻¹³ cm²/dyne (1.5×10⁻¹³ N/m²) or less.

The preferred optical characteristics of the base film of cyclic olefin-based addition polymer differ somewhat with the mode of the liquid crystal cell to which it is applied. When the base film is applied to TN mode liquid crystal cell, the in-plane retardation Re (630) is preferably 15 nm or less, more preferably 11 nm or less. The thickness-direction retardation Rth (630) is preferably from 40 to 120 nm, more preferably from 60 to 100 nm. The optically-compensatory sheet for TN mode liquid crystal cell is obtained by forming an alignment layer and a discotic liquid crystal layer on the base film of cyclic olefin-based addition polymer.

When the base film is applied to VA mode liquid crystal cell, Re (630) is preferably 15 nm or less, more preferably 11 nm or less. Rth (630) is preferably from not smaller than 120 nm to not greater than 300 nm, more preferably from not smaller than 150 nm to not greater than 260 nm. The optically-compensatory sheet for VA mode liquid crystal cell is obtained by forming an alignment layer and a rod-shaped liquid crystal layer on the base film of cyclic olefin-based addition polymer.

When the base film is applied to OCB mode liquid crystal cell, Re (630) is preferably from not smaller than 30 nm to not greater than 70 nm, more preferably not smaller than 35 nm to not greater than 55 nm. Rth (630) is preferably not smaller than 120 nm to not greater than 300 nm, more preferably from not smaller than 150 nm to not greater than 260 nm. The optically-compensatory sheet for OCB mode liquid crystal cell is obtained by forming an alignment layer and a discotic liquid crystal layer on the base film of cyclic olefin-based addition polymer.

[Polarizing Plate]

In general, a polarizing plate includes a polarizer and two transparent protective films disposed at both sides of the polarizer. The optically-compensatory sheet of the invention may be used as at least one of the two protective films. A typical cellulose acetate film may be used for the other protective film. The polarizer may include, for example, an iodine-based polarizer, a dye-based polarizer using a dichroic dye, and a polyene-based polarizer. The iodine-based polarizer and the dye-based polarizer are generally produced using a polyvinyl alcohol-based film. When the optically-compensatory sheet of the invention is used as a polarizing plate protective film, the optically-compensatory sheet is subject to a surface treatment which will be described later, and then the surface-treated optically-compensatory sheet is attached to the polarizer by means of an adhesive. The adhesive used may include, for example, a polyvinyl alcohol-based adhesive which contains polyvinyl alcohol, polyvinyl butyral, etc., vinyl-based latex which contains butylacrylate or the like, gelatin, etc. The polarizing plate is composed of the polarizer and the protective films to protect both sides of the polarizer. A protection film is attached to one side of the polarizing plate, while a separate film is attached to the other side of the polarizer. The protection film and the separate film are used to protect the polarizing plate when the polarizing plate is shipped or tested. In this case, the protection film is attached to a side opposing a side at which the polarizing plate is attached to a liquid crystal plate to protect a surface of the polarizing plate. The separate film is attached to the side at which the polarizing plate is attached to the liquid crystal plate to cover an adhesive layer attached to the liquid crystal plate.

[Formation of Optically Anisotropic Layer]

The optically-compensatory sheet of the invention has an optically anisotropic layer provided on the base film of cyclic olefin-based addition polymer. The optically anisotropic layer is made of a liquid crystal compound, non-liquid crystal compound, inorganic compound, organic/inorganic complex compound or the like. Preferred among these materials is liquid crystal compound. As such a liquid crystal compound there may be used one obtained by orienting a low molecular compound having a polymerizable group, and then fixing the orientation by optical or thermal polymerization or one obtained by heating a liquid crystal polymer so that it is aligned, and then cooling the liquid crystal polymer so that it is fixed aligned in glass state. As such a liquid crystal compound there may be used one having a disc-shaped structure, one having a rod-shaped structure or one having an optical biaxiality. As such a non-liquid crystal compound there may be used a polymer having an aromatic ring such as polyimide and polyester.

A method of forming an optically anisotropic layer from a liquid crystal compound will be described hereinafter.

(Oriented Film)

In order to define the direction of alignment of the liquid crystal compound constituting the optically anisotropic layer, an oriented film is preferably used. The oriented film can be provided by the rubbing of an organic compound (preferably polymer), the oblique vacuum deposition of an inorganic compound, the formation of a layer having a microgroove or the accumulation of an organic compound (e.g., co-tricosanoic acid, dioctadecylmethyl ammonium chloride, methyl stearate) by Langmuir-Blodgett method (LB film). Further, an oriented film which acts to perform alignment when given an electric or magnetic field or irradiated with light is known. The oriented film is preferably formed by the rubbing of a polymer. Rubbing is effected several times using a paper or cloth in a predetermined direction. A cloth obtained by uniformly weaving fibers having a uniform length and thickness is preferably used. The liquid crystal molecules of the optically anisotropic layer which have once been fixed aligned can be kept aligned even if the oriented film is removed. In other words, the oriented film is essential in the production of optically-compensatory sheet to align the liquid crystal molecules but is not essential in the optically-compensatory sheet produced. Prior to provision of the oriented film interposed between the base film of cyclic olefin-based addition polymer and the optically anisotropic layer, the base film of cyclic olefin-based addition polymer is preferably subjected to surface treatment. Examples of the surface treatment to be conducted herein include corona discharge treatment, glow discharge treatment, and flame treatment. These surface treatment methods will be further described later. The surface treatment is optionally followed by the provision of an undercoat layer (adhesive layer) interposed between the base film of cyclic olefin-based addition polymer and the oriented film.

Examples of the organic compound for oriented film include polymers such as polymethyl methacrylate, acrylic acid/methacrylic acid copolymer, styrene/maleimide copolymer, polyvinyl alcohol, poly(N-methylol acrylamide), styrene/vinyl toluene copolymer, chlorosulfonated polyethylene, nitrocellulose, polyvinyl chloride, chlorinated polyolefin, polyester, polyimide, vinyl acetate/vinyl chloride copolymer, ethylene/vinyl acetate copolymer, carboxymethyl cellulose, polyethylene, polypropylene and polycarbonate, and compounds such as silane coupling agent. Preferred examples of the polymer include polymers such as polyimide, polystyrene and styrene derivative, gelatin, polyvinyl alcohols, and alkyl-modified polyvinyl alcohols having an alkyl group (preferably having 6 or more carbon atoms).

Particularly preferred among these polymers are alkyl-modified polyvinyl alcohols, which are excellent in capability of uniformly aligning liquid crystal compound. This is presumably because the alkyl chain in the surface of the oriented film and the alkyl side chain in the liquid crystal undergo strong mutual action. The alkyl group preferably has from 6 to 14 carbon atoms. More preferably, the alkyl group is connected to the polyvinyl alcohol via —S—, —(CH₃)C(CN)— or —(C₂H₅)N—CS—S—. The aforementioned alkyl-modified polyvinyl alcohol is terminated by an alkyl group. The alkyl-modified polyvinyl alcohol preferably has a saponification degree of 80% or more and a polymerization degree of 200 or more. As the polyvinyl alcohol having an alkyl group in its side chains there may be used any of MP103, MP203 and R1130, which are commercially available from KURARAY CO., LTD.

Polyimide films (preferably fluorine atom-containing polyimide) which have been widely used as oriented film for LCD are preferably used as organic oriented film. These polyimide films are obtained by spreading a polyamic acid (e.g., LQ/LX Series, produced by Hitachi Chemical Co., Ltd., SE Series, produced by NISSAN CHEMICAL INDUSTRIES, LTD.) over the surface of a substrate, baking the coated substrate at a temperature of from 100° C. to 300° C. for 0.5 to 1 hour, and then rubbing the coated substrate.

Further, the oriented film to be applied to the base film of cyclic olefin-based addition polymer of the invention is preferably a cured film obtained by introducing a reactive group into the aforementioned polymer or by curing the aforementioned polymer in the presence of an isocyanate compound and a crosslinking agent such as epoxy compound.

The polymer constituting the oriented film and the liquid crystal compound in the optically anisotropic layer preferably undergo chemical bonding to each other at the interface of these layers. The polymer constituting the oriented film is preferably formed by a polyvinyl alcohol having at least one hydroxyl group substituted by a group having a vinyl moiety, oxylanyl moiety or aziridinyl moiety. The group having a vinyl moiety, oxylanyl moiety or aziridinyl moiety is preferably connected to the polymer chain in the polyvinyl alcohol derivative via an ether bond, urethane bond, acetal bond or ester bond. The group having a vinyl moiety, oxylanyl moiety or aziridinyl moiety is preferably free of aromatic ring. The aforementioned polyvinyl alcohol is preferably Compound (ka-22) disclosed in JP-A-9-152509.

The optically anisotropic layer is laminated on the base film of cyclic olefin-based addition polymer in a continuous length. A solution of oriented film composition is continuously spread over a film in a continuous length while being conveyed over the film to form an oriented film the surface of which is then continuously rubbed. A liquid crystal compound solution is then continuously spread over the oriented film to obtain an optically-compensatory sheet in a continuous length.

The direction of the slow axis of the optically anisotropic layer in the optically-compensatory sheet in a continuous length is substantially parallel to the surface of the film. In the case where the oriented film formed on the continuous film is continuously rubbed while being conveyed to align the liquid crystal molecules, the oriented film material can be properly selected depending on which the liquid crystal molecules are aligned in the direction parallel to or perpendicular to the longitudinal direction. In order to develop the slow axis of the optically anisotropic layer parallel to the rubbing direction (that is, parallel to the longitudinal direction), a polyvinyl alcohol-based oriented film may be used. Further, in order to develop the slow axis of the optically anisotropic layer perpendicular to the rubbing direction (that is, perpendicular to the longitudinal direction), a perpendicularly aligned layer disclosed in JP-A-2002-98836, paragraphs [0024]-[0210] may be used. On the other hand, the polarizer comprising iodine which has been widely used is produced by a continuous longitudinal monoaxial stretching process and thus has an absorption axis parallel to the longitudinal direction of the roll. Accordingly, in order to laminate an ordinary longitudinally monoaxially stretched continuous polarizer and a continuous optically-compensatory sheet on each other in roll-to-roll manner such that the absorption axis of the polarizer and the slow axis of the optically anisotropic layer are perpendicular to each other, the aforementioned perpendicularly aligned layer is preferably used.

(Liquid Crystalline Compound)

The liquid crystal to be used in the optically anisotropic layer is preferably made of a discotic compound or a rod-shaped compound.

For the details of discotic compound, reference can be made to JP-A-7-267902, JP-A-7-281028, and JP-A-7-306317. As disclosed in these patent references, the optically anisotropic layer is a layer having a negative birefringence made of a compound having a discotic structural unit. In other words, the optically anisotropic layer is a layer of a low molecular liquid crystal discotic compound such as monomer or a polymer layer obtained by the polymerization (curing) of a polymerizable liquid crystal discotic compound. Examples of the discotic (disc-shaped) compound include benzene derivatives disclosed in C. Destrade et al's study report, “Mol. Cryst.,” vol. 71, page 111 (1981), truxene derivatives disclosed in C. Destrade and et al's study report, “Mol. Cryst.,” vol. 122, page 141 (1985), and “Physics lett,” A, vol. 78, page 82 (1990), cyclohexane derivatives disclosed in B. Kohne et al's study report, “Angew. Chem.,” vol. 96, page 70 (1984), and azacrown-based or phenyl acetylene-based macrocycles disclosed in J. M. Lehn et al's study report, “J. Chem. Commun.,” page 1,794 (1985), J. Zhang et al's study report, “J. Am. Chem. Soc.,” vol. 116, page 2,655 (1994). The aforementioned discotic (disc-shaped) compound is normally disposed as nucleus at the center of the molecule. Straight-chain alkyl or alkoxy groups, substituted benzoyloxy groups, etc. are radially disposed as straight chain in the structure. This structure shows liquid crystal properties and is normally called discotic liquid crystal. However, if the molecule itself has a negative monoaxiality and thus can give a predetermined alignment, it is not limited by the aforementioned description. The term “formed by a disc-shaped compound” as used in the aforementioned patent is meant to indicate that the final product is not necessarily the aforementioned compound, but the aforementioned low molecular discotic compound has a group which reacts when heated or irradiated with light and thus concurrently undergoes polymerization or crosslinking when heated or irradiated with light to increase its molecular mass and lose liquid crystal properties. Further, a compound containing at least disc-shaped compound capable of forming a discotic nematic phase or monoaxial columnar phase and having an optical anisotropy is preferably used. The disc-shaped compound is preferably a triphenylene derivative. The triphenylene derivative is preferably a compound represented by the formula (ka-2) disclosed in JP-A-7-306317.

Preferred examples of the rod-shaped compound having liquid crystal properties (rod-shaped liquid crystal compound) employable herein include azomethines, azoxys, cyanobiphenyls, cyanophenylesters, benzoic acid esters, cyclohexanecarboxylic acid phenyl esters, cyanophenyl cyclophexanes, cyano-substituted phenylpyrimdines, alkoxy-substituted phenylpyrimidines, phenyldioxanes, tolans, and alkenyl cyclohexylbenzonitriles. Besides the aforementioned low molecular liquid crystal compounds, liquid crystal polymer compounds may be used. The rod-shaped liquid crystal compound is preferably fixed aligned. As the liquid crystal molecule there is preferably used one having a partial structure capable of causing polymerization or crosslinking reaction when irradiated with active rays or electron rays or when heated. The number of partial structures is from 1 to 6, preferably from 1 to 3. As the polymerizable rod-shaped liquid crystal compound there may be used any of those disclosed in “Makromol. Chem.,” vol. 190, page 2,255, 1989, “Advanced Materials,” vol. 5, page 107, 1993, U.S. Pat. Nos. 4,683,327, 5,622,648 and 5,770,107, International Patent Disclosure WO95/22586, 95/24455, 97/00600, 98/23580, 98/52905, JP-A-1-272551, JP-A-6-16616, JP-A-7-110469, JP-A-11-80081, and JP-A-2001-328973.

(Formation of Liquid Crystal Layer)

The optically anisotropic layer can be formed by spreading a coating solution containing a liquid crystal compound and optionally a polymerization initiator and arbitrary components over the oriented film. As the solvent to be used in the preparation of the coating solution there is preferably used an organic solvent. Examples of the organic solvent employable herein include amides (e.g., N,N-dimethylformamide), sulfoxides (e.g., dimethyl sulfoxide), heterocyclic compounds (e.g., pyridine), hydrocarbons (e.g., benzene, hexane), alkyl halides (e.g., chloroform, dichloromethane), esters (e.g., methyl acetate, butyl acetate), ketones (e.g., acetone, methyl ethyl ketone), and ethers (e.g., tetrahydrofurane, 1,2-dimethoxyethane). Preferred among these organic solvents are alkyl halides and ketones. Two or more of these organic solvents may be used in combination. The spreading of the coating solution is accomplished by any known method (e.g., extrusion coating method, direct gravure coating method, reverse gravure coating method, die coating method). The thickness of the optically anisotropic layer is preferably from 0.5 μm to 100 μm, more preferably from 0.5 μm to 30 μm.

The fixing of alignment of the liquid crystal molecules is preferably accomplished by polymerization reaction. Examples of the polymerization reaction employable herein include heat polymerization reaction involving the use of a heat polymerization initiator and photopolymerization reaction involving the use of a photopolymerization initiator. The photopolymerization reaction is preferably effected in the invention. Examples of the photopolymerization initiator employable herein include α-carbonyl compounds (as disclosed in U.S. Pat. Nos. 2,367,661 and 2,367,670), acyloin ethers (as disclosed in U.S. Pat. No. 2,448,828), α-hydrocarbon substituted aromatic acyloin compounds (as disclosed in U.S. Pat. No. 2,722,512), polynuclear quinone compounds (as disclosed in U.S. Pat. Nos. 3,046,127 and 2,951,758), combinations of triarylimidazole dimer and p-aminophenylketone (as disclosed in U.S. Pat. No. 3,549,367), acridine and phenazine compounds (as disclosed in JP-A-60-105667 and U.S. Pat. No. 4,239,850), and oxadiazole compounds (as disclosed in U.S. Pat. No. 4,212,970). The amount of the photopolymerization initiator to be used is preferably from 0.01 to 20% by mass, more preferably from 0.5 to 5% by mass based on the solid content of the coating solution. As the light with which the liquid crystal molecules are irradiated to cause polymerization there is preferably used ultraviolet ray. The radiation energy is preferably from 20 mJ/cm² to 5,000 mJ/cm², more preferably from 100 mJ/cm² to 800 mJ/cm². In order to accelerate photopolymerization reaction, irradiation with light may be effected under heating. A protective layer may be provided on the optically anisotropic layer.

The combined use of a plasticizer, a surface active agent, a polymerizable monomer, etc. with the aforementioned liquid crystal molecules makes it possible to enhance the uniformity of coat layer, the strength of layers, the alignment of liquid crystal molecules, etc. These compositions preferably have some compatibility with the liquid crystal molecules and do not inhibit the alignment of the liquid crystal molecules.

Examples of the polymerizable monomer employable herein include radical-polymerizable or cationically polymerizable compounds. Polyfunctional radical-polymerizable monomers are preferred. More preferably, these polyfunctional radical-polymerizable monomers are copolymerizable with the aforementioned liquid crystal compound containing a polymerizable group. Examples of these polyfunctional monomers include those disclosed in JP-A-2002-296423, paragraphs [0018]-[0020]. The added amount of the aforementioned compound is normally from 1 to 50% by mass, preferably from 5 to 30% by mass based on the mass of the disc-shaped liquid crystal molecules.

(Formation of Optically Anisotropic Layer)

How the optically anisotropic layer comprises a polymer film incorporated therein will be described hereinafter. As the non-liquid crystal polymer to be incorporated in the polymer film there is preferably used at least one polymer selected from the group consisting of polyamide, polyimide, polyester, polyether ketone, polyamide imide, polyester imide and polyaryl ether ketone. A solution having such a polymer dissolved in a solvent is spread over a base film of cyclic olefin-based addition polymer and then dried to remove the solvent. In this manner, an optically anisotropic layer is formed. During this procedure, the polymer film and the base film are preferably stretched to further develop optical anisotropy so that an optically anisotropic layer is formed. Alternatively, the aforementioned non-liquid crystal polymer film may be prepared on a separate substrate. The non-liquid crystal polymer film is peeled off the substrate, and then laminated on a base film of cyclic olefin-based addition polymer. The thickness of the non-liquid crystal polymer film is preferably 50 μm or less, more preferably from 1 to 20 μm.

For the details of preparation of the optically anisotropic layer made of a non-liquid crystal polymer, reference can be made to JP-A-2003-315554 using the designation of “optically anisotropic layer (B)”.

(Characteristic of Optically Anisotropic Layer)

The thickness-direction retardation Rth of the optically-compensatory sheet of the invention thus obtained preferably satisfies the following expression:
40 nm≦Rth(630)≦300 nm

More preferably, the expression 120 nm≦Rth (630)≦260 nm is satisfied. When Rth (630) falls within the above defined range, the optically-compensatory sheet can be used to improve the viewing angle of VA mode liquid crystal display devices.

(Preparation of Polarizing Plate)

The polarizing plate of the invention is prepared by laminating a polarizer and two sheets of protective layers (protective film) on each other with an adhesive. As at least one of the protective films there is preferably used an optically-compensatory sheet of the invention. As the other protective film there may be used an ordinary cellulose triacetate film. A method of producing the polarizing plate of the invention will be sequentially described hereinafter.

(Binder Constituting Polarizing Layer)

The polarizing layer can be formed by aligning polarizing dyes dispersed in PVA in one direction. PVA is normally obtained by saponifying a polyvinyl acetate. PVA may contain a component copolymerizable with vinyl acetate such as unsaturated carboxylic acid, unsaturated sulfonic acid, olefin and vinyl ether. Alternatively, a modified PVA containing acetoacetyl group, sulfonic acid group, carboxyl group and oxyalkylene group may be used. The saponification degree of PVA is not specifically limited but is preferably from 80 to 100 mol %, particularly from 90 to 100 mol % from the standpoint of solubility, etc. The polymerization degree of PVA is not specifically limited but is preferably from 1,000 to 10,000, particularly from 1,500 to 5,000.

(Dyeing of Polarizing Layer)

The dyeing of the polarizing layer is carried out by dipping a PVA film in an aqueous solution of iodine-potassium iodide. The content of iodine is preferably from 0.1 to 20 g/l and the content of potassium iodide is preferably from 1 to 200 g/l. The mass ratio of iodine to potassium iodide is preferably from 1 to 200. The dyeing time is preferably from 10 to 5,000 seconds. The temperature of the dyeing solution is preferably from 5° C. to 60° C. The dyeing of the polarizing layer is carried out not only by dipping but also by an arbitrary method such as spreading and spraying of iodine-dye solution. The dyeing step may be effected either before or after the stretching step. However, it is particularly preferred that the dyeing of the polarizing layer be effect in liquid phase before the stretching step because the film can properly swell and thus can be easily stretched.

The polarizing plate of the invention may comprise dyes other than iodine incorporated therein. Preferred examples of the dyes other than iodine include dye-based compounds such as azo-based dye, stilbene-based dye, pyrazolone-based dye, triphenylmethane-based dye, quinoline-based dye, oxazine-based dyes, thiazine-based dye and anthraquinone-based dye.

(Curing of Polarizing Layer)

In order to fix the orientation structure of PVA after stretching, PVA is preferably crosslinked. As a crosslinking agent there may be used one disclosed in US Reissued Pat. 232,897. However, boric acid and borax are preferably used practically. A salt of metal such as zinc, cobalt, zirconium, iron, nickel and manganese may be used as well. The curing of the polarizing layer is carried out by dipping PVA impregnated with a dye in an aqueous solution of borax or boric acid. The content of borax or boric acid is preferably from 0.1 to 10 mol/l, more preferably from 0.2 to 5 mol/l, even more preferably from 0.2 to 2 mol/l. The temperature of the curing solution is from 10° C. to 4° C., more preferably from 15° C. to 35° C. The dipping time is from 10 seconds to 10 minutes, more preferably from 20 seconds to 5 minutes. This curing solution preferably comprises an iodide such as sodium iodide and potassium iodide incorporated therein. The concentration of iodide is preferably from 0.1 to 10 mol/l, more preferably from 0.2 to 5 mol/l, even more preferably from 0.2 to 2 mol/l. Curing may be effected at any of steps before, during and after stretching.

(Stretching of Polarizing Layer)

Prior to stretching, PVA film is allowed to swell. The swell of PVA film is from 1.2 to 2.0 (mass ratio of before to after swelling). Thereafter, PVA film is stretched at a bath temperature of from 15° C. to 50° C., preferably from 17° C. to 40° C. in an aqueous medium bath or a dye bath having a dichromatic material dissolved therein while being continuously conveyed over a guide roll, etc. The stretching of PVA film is carried out by keeping the conveying speed of the latter stage nip roll higher than that of the former stage nip roll while gripping PVA film by the two pair of nip rolls. The stretching ratio is hereinafter based on the ratio of length of film stretched to initial film. The stretching ratio is from 1.2 to 3.5, preferably from 1.5 to 3.0 from the standpoint of the aforementioned advantage. Thereafter, PVA film is dried at a temperature of from 50° C. to 90° C. to obtain a polarizer.

(Surface Treatment of Base Film of Cyclic Olefin-Based Addition Polymer)

In the invention, before coating the adhesive to improve the adhesion of the polarizer to the base film of the cyclic olefin-based addition polymer, a surface (a side opposing a coating side of the optically anisotropic layer) of the base film of the cyclic olefin-based addition polymer is subject to a surface treatment. Examples of the surface treatment to be conducted herein include preferably glow discharge treatment, UV radiation treatment, corona discharge treatment, and flame treatment without being limited thereto. Here, the glow discharge treatment refers to so-called low temperature plasma caused under low pressure gas. In the invention, a plasma treatment under atmospheric pressure is also preferable. Besides, details of the glow discharge treatment are disclosed in U.S. Pat. Nos. 3,462,335, 3,761,299 and 4,072769 and UK Patent 891,469. In addition, there may be used a method disclosed in JP-T-59-556430 in which only gas species that are generated in a container by subjecting a polyester support itself to a discharge treatment after discharge starts comprise discharge atmosphere gas composition. In addition, for a vacuum glow discharge treatment, there may be applied a method disclosed in JP-T-60-16614 in which a film is subject to a discharge treatment under a condition where a surface temperature of the film is more than 80° C. and less than 180° C.

The degree of a vacuum in the glow discharge treatment is preferably 0.5 to 3000 Pa, more preferably 2 to 300 Pa. An application voltage is preferably 500 to 5000 V, more preferably 500 to 3000 V. A discharge frequency used is preferably 0 to several thousands MHz, more preferably 50 Hz to 20 MHz, even more preferably 1 KHz to 1 MHz. Discharge treatment strength is preferably 0.01 KV·A·minute/m² to 5 KV·A·minute/m², more preferably 0.15 KV·A·minute/m² to 1 KV·A·minute/m².

In the invention, as the surface treatment, UV radiation is preferably conducted according to, for example, treatment methods disclosed in JP-T-43-2603, JP-T-43-2604 and JP-T-45-3828. A mercury lamp used is a high pressure mercury lamp formed of a quartz tube, and an UV wavelength is preferably 180 to 380 nm. For the UV radiation, a high pressure mercury lamp having a dominant wavelength of 365 nm may be used as a light source if rising of surface temperature of film to 150° C. or so has no effect on performance of a support. A low pressure mercury lamp having a dominant wavelength of 254 nm is preferable for a low temperature treatment. In addition, ozoneless high pressure mercury lamp and low pressure mercury lamp are possibly used. As treatment light intensity increases, the adhesion between the base film of the cyclic olefin-based addition polymer and the polarizer becomes enhanced. However, with the increase of the light intensity, there may arise a problem that the film is colored and weakened. Accordingly, for the high pressure mercury lamp having the dominant wavelength of 365 nm, radiation light intensity is preferably 20 to 10000 (mJ/cm²), more preferably 50 to 2000 (mJ/cm²). For the low pressure mercury lamp having the dominant wavelength of 254 nm, radiation light intensity is preferably 100 to 10000 (mJ/cm²), more preferably 300 to 1500 (mJ/cm²).

In addition, in the invention, the corona discharge treatment is also preferably used as the surface treatment according to, for example, treatment methods disclosed in JP-T-39-12838, JP-A-47-19824, JP-A-48-28067 and JP-A-52-42114. As a corona discharge treatment apparatus, there may be used a solid state corona treatment apparatus, an LEPEL type surface treatment apparatus, a VETAPHON type treatment apparatus, etc., which are commercially available from Pillar Co., Ltd. The surface treatment may be conducted under a normal pressure in air. A discharge frequency for the surface treatment is preferably 5 to 40 KV, more preferably 10 to 30 KV, and a waveform is preferably an alternating sinusoidal waveform. A gap transparency length of electrode and dielectric roll is preferably 0.1 to 10 mm, more preferably 1.0 to 2.0 mm. Discharge treatment is conducted over a dielectric support roller provided in a discharge zone, and the strength of discharge treatment is preferably 0.3 to 0.4 KV·A·minute/m², more preferably 0.34 to 0.38 KV·A·minute/m².

In the invention, the flame treatment is also preferably used as the surface treatment. Although gas used may be any of natural gas, liquefied propane gas and city gas, a mixture ratio of gas to air is important.

This is because it is believed that the effect of surface treatment by the flame treatment is caused by plasma containing active oxygen. An important point for the effect of flame surface treatment is plasma activity (temperature), which is an important factor of flame, and the amount of oxygen contained in plasma. A dominant factor of this point is a gas/oxygen ratio. When gas reacts with oxygen in exact quantities, an energy density become maximal and thus plasma activity becomes raised. Specifically, a preferred natural gas/air mixture ratio is 1/6 to 1/10, preferably 1/7 to 1/9 in volume ratio. In addition, a liquefied propane gas/air mixture ratio is 1/14 to 1/22, preferably 1/16 to 1/19, and a city gas/air mixture ratio is 1/2 to 1/8, preferably 1/3 to 1/7. The flame treatment amount is preferably 1 to 50 Kcal/m², more preferably 3 to 20 Kcal/m². A distance between a leading edge of burner inner flame and a film is preferably 3 to 7 cm, more preferably 4 to 6 cm. A nozzle shape of a burner is preferably a ribbon type of Flinburner, Co., Ltd. (US), a porous type of Wise Co., Ltd. (US), a ribbon type of Aerogen Co., Ltd. (UK), a zigzag porous type of Kasuga Electric Works Ltd. (JP), a zigzag porous type of Koike Sanso Kogyo Co., Ltd. (JP), etc. A backup roll supporting the film in the flame treatment is a hollow roll. The backup roll is cooled by a coolant, and the flame treatment is preferably conducted at a constant temperature of 20 to 50° C.

Although the extent of surface treatment is varied depending on the kind of surface treatment and the kind of cyclic olefin-based addition polymer, an angle of contact of treated surface of film with pure water is preferably less than 50°, more preferably more than 25° and less than 40°. If the contact angle of film surface with pure water falls within the above range, strength of the adhesion of the base film of the cyclic olefin-based addition polymer to the polarizer becomes increased.

(Adhesive)

In the invention, when the polarizer made of polyvinylalcohol is attached to the surface-treated base film of the cyclic olefin-based addition polymer, an adhesive containing a water-soluble polymer is used.

Examples of the water-soluble polymer preferably used for the adhesive may include homopolymer or copolymer having, as constituent elements, ethylenically unsaturated monomers such as N-vinylpyrrolidone, acrylic acid, methacrylic acid, maleic acid, acrylic acid β-hydroxyethyl, methacrylic acid β-hydroxyethyl, vinylalcohol, methylvinylether, vinyl acetate, acrylamide, methacrylamide, diacetoneacrylamide, vinylimidazole and the like, polyoxyethylene, polyoxypropylene, poly-2-methyloxazoline, methylcellulose, hydroxyethylcellulose, hydroxypropylcellulosegelatin, etc. In the invention, among these polymers, PVA and gelatin are preferably used.

A preferred characteristic of PVA used for the adhesive is the same as that of PVA used for the aforementioned polarizer. In the invention, a crosslinking agent is preferably used as well. Examples of the crosslinking agent preferably used when PVA is used for the adhesive may include boric acid, polyhydric aldehyde, multifunctional isocyanate compound, multifunctional epoxy compound, etc. In the invention, among these compounds, boric acid is particularly preferably used.

Examples of gelatin used for the adhesive may include lime-treated gelatin, acid-treated gelatin, enzyme-treated gelatin, gelatin derivatives, modified gelatin, etc. Among these gelatins, lime-treated gelatin and acid-treated gelatin are preferably used. When gelatin is used for the adhesive, examples of the crosslinking agent preferably used as well may include activated halogen compound (2,4-dichlor-6-hydroxy-1,3,5-triazine, its sodium salt, etc.), activated vinyl compound (vinyl-based polymer having 1,3-bisvinylsulfonyl-2-propanol, 1,2-Bis(vinylsulfonylaceteamide)ethane, bis(vinylsulfonylmethyl)ether or vinylsulfonyl group in side chains of the polymer, etc.), N-carbamoylpyridinium salts ((1-morpholinocarbonyl-3-pyridinio)methanesulfonate, and the like), haloamidinium salts (1-(1-chloro-1-pyridinomethylene)pyrrolidinium2-naphthalenesulfonate, and the like), etc. In the invention, activated halogen compound and activated vinyl compound are particularly preferably used.

The addition amount of crosslinking agent used as well is preferably more than 0.1 mass % and less than 40 mass %, more preferably more than 0.5 mass % and less than 30 mass % for the water-soluble polymer in the adhesive. It is preferable that the adhesive is coated on at least one surface of the protective film or the polarizer to form an adhesive layer thereon, and the adhesive is coated on the treated surface of the protective film to form an adhesive layer thereon. After drying the adhesive layer, thickness of the adhesive layer is preferably 0.01 to 5 μm, more preferably 0.05 to 3 μm.

(Antireflection Layer)

A functional film such as an antireflection layer is preferably provided in the protective film of the polarizing plate, which is disposed at the opposite side to a liquid crystal cell. Particularly, in the invention, an antireflection layer including at least a light scattering layer and a low refractive index layer laminated in order on the protective film or an antireflection layer including a medium refractive index layer, a high refractive index layer and a low refractive index layer laminated in order on the protective film is fairly used. Preferred examples thereof will be described below.

First, preferred examples of the antireflection layer including the light scattering layer and the low refractive index layer provided on the protective film will be described. Mat particles are dispersed in the light scattering layer. A refractive index of materials other than the mat particles in the light scattering layer is preferably in a range of 1.50 to 2.00, and a refractive index of the low refractive index layer is preferably in a range of 1.35 to 1.49. In the invention, the light scattering layer has both of antiglare property and hard coat property, and may be either a single layer or a multi layer, for example, 2 to 4 layers.

When the antireflection layer is designed for its surface unevenness such that a center line average roughness Ra is 0.08 to 0.40 μm, a 10 point average roughness Rz is ten times less than Ra, an average mountain peak-to-peak distance Sm is 1 to 100 μm, a standard deviation of heights of convex portion from deepest point of unevenness is less than 0.5 μm, a standard deviation of average mountain peak-to-peak distances Sm with reference to a center line is less than 20 μm, and a percentage of planes having an inclination angle of 0 to 5 degree is more than 10%, it is possible to attain sufficient antiglare and uniform mat feeling in naked eyes.

In addition, when and a ratio of minimum value to maximum value of reflectivity in a range of a*value-2˜2, b*value-3˜3 and 380 nm to 780 nm is 0.5 to 0.99, hue of reflection light under a C light source becomes preferably neutralized. In addition, when b*value of transmission light under the C light source is 0 to 3, yellow hue of white display in a display device becomes preferably reduced.

In addition, when the luminance distribution on the film, with a grid of 120 μm×40 μm interposed between a surface light source and the antireflection layer, is measured, if a standard deviation of luminance distribution is less than 20, flickering when the sheet of the invention is applied to a high precision panel becomes preferably reduced.

When mirror reflectivity is set to be less than 2.5%, transmittance set to be more than 90% and 60° glossiness set to be less than 70% as optical characteristics, the antireflection layer of the invention is preferably used since it can suppress reflection of external light and improve visibility. In particular, the mirror reflectivity is preferably less than 1%, more preferably less than 0.5%. When haze is 20% to 50%, an internal haze/total haze ratio is 0.3 to 1, a rate of reduction of haze value after formation of the low refractive index layer from haze value up to the light scattering layer is less than 15%, transmission image definition at comb teeth width of 0.5 mm is 20% to 50%, and a ratio of vertical transmission light to transmission light in a direction inclined by 20 with respect to the vertical direction is 1.5 to 5.0, flickering on a high precision LCD panel can be suppressed, and blur of characters and so on can be reduced.

(Low Refractive Index Layer)

A refractive index of the low refractive index layer in the antireflection layer of the invention is in a range of 1.20 to 1.49, preferably 1.30 to 1.44. The low refractive index layer is preferable for low reflectivity when it satisfies the following equation (IX).
Equation (IX)=(mλ/4)×0.7<n1d1<(mλ/4)×1.3

In the above equation, m is an odd number, n1 is a refractive index of the low refractive index layer, d1 is film thickness (nm) of the low refractive index layer, and λ is wavelength of 500 to 550 nm.

Material of the low refractive index layer of the invention will be described below.

The low refractive index layer of the invention contains a fluorine-containing polymer as a low refractive index binder. As the fluorine-containing polymer, there may be used a fluorine-containing polymer having a dynamic friction coefficient of 0.03 to 0.20, a contact angle with water of 90 to 120° C., and a sliding angle of pure water of less than 70° and being crosslinked by ionizing radiation. When the antireflection layer of the invention is equipped in an image display device, a lower peeling force exerting between the layer and a commercially available adhesive tape is preferable since a sticker or a memo attached to the layer can be easily detached from the layer. The peeling force is preferably less than 500 gf, more preferably less than 300 gf, even more preferably less than 100 gf. As surface hardness measured by a micro hardness tester becomes higher, scratches becomes more difficult to occur in the layer. The surface hardness is preferably more than 0.3 GPa, more preferably more than 0.5 GPa.

Examples of the fluorine-containing polymer used for the low refractive index layer may include hydrolysate and dehydrated condensate of perfluoroalkyl group-containing silane compound (e.g., (heptadecafluoro-1,1,2,2-tetrahydrodecyl)triethoxysilane, etc.), fluorine-containing copolymer containing a fluorine-containing monomer unit and a constituent unit to give crosslinking reactivity as constituent component, etc.

Examples of the fluorine-containing monomer may include fluoroolefins (e.g., fluoroethylene, vinylidenefluoride, tetrafluoroethylene, perfluorooctylethylene, hexafluoropropylene, perfluoro-2,2-dimethyl-1,3-dioxole, etc.), partially or completely fluorinated alkylester derivatives of (math)acrylic acid (e.g., biscoat 6FM (produced by Osaka Organic Chemical Industry Ltd.), M-2020 (produced by Daikin Industries, Ltd.), etc.), completely or partially fluorinated vinylethers, etc. Among these monomers, perfluoroolefins are preferable, and hexafluoropropylene is particularly preferable from the standpoint of refractive index, solubility, transparency, availability, etc.

Examples of the constituent unit to give crosslinking reactivity may include a constituent unit which can be obtained by polymerization of monomer having a self-crosslinking functional group in a molecule, such as glycidyl(math)acrylate or glycidylvinlyether, a constituent unit which can be obtained by polymerization of monomer having a carboxyl group, a hydroxyl group, an amino group, a sulfonic group, etc., (e.g., (math)acrylic acid, methylol(math)acrylate, hydroxyalkyl(math)acrylate, allylacrylate, hydroxyethylvinylether, hydroxybutylvinylether, maleic acid, crotonic acid, etc.), a constituent unit having a crosslinking reactive group such as (math)acryloyl group introduced into the aforementioned constituent units by polymerization reaction (for example, the crosslinking reactive group may be introduced by reaction of hydroxyl group with acrylic acid chloride), etc.

In addition to the above fluorine-containing monomer unit and the above constituent unit to give crosslinking reactivity, monomers which do not contain fluorine atoms may be copolymerized from the standpoint of solubility to solvent, transparency of film, etc. Usable monomers are not particularly limited, but may include, for example, olefins (ethylene, propylene, isoprene, vinyl chloride, vinylidene chloride, etc.), acrylic acid esters (acrylic acid methyl, acrylic acid ethyl, crylic acid ethyl, acrylic 2-ethylhexyl, etc.), methacrylic acid esters (methacrylic acid methyl, methacrylic acid ethyl, methacrylic acid butyl, ethyleneglycoldimethacylate, etc.), styrene derivatives (styrene, divinylbenzene, vinlytoluene, α-methylstyrene, etc.), vinlyethers (methylvinylether, ethylvinylether, cyclohexylvinylether, etc.), vinylesters (acetic acid vinyl, propionic acid vinyl, cinnamic acid vinyl, etc.), acrylamides (N-tert-butylacrylamide, N-cyclohexylacrylamide, etc.), methacrylamides, acrylonitrile derivatives, etc.

The aforementioned polymers may be used in combination of a curing agent, as disclosed in JP-A-10-25388 and JP-A-10-147739.

(Light Scattering Layer)

A light scattering layer is formed to give the film light diffusivity by surface scattering and/or internal scattering and hard coat property to improve scratch resistance of film. Accordingly, the light scattering layer may contain a binder to give the hard coat property, mat particles to give the light diffusivity, and optionally an inorganic filler for high refractive index, crosslinking shrinking prevention and high strength.

Film thickness of the light scattering layer is preferably 1 to 10 μm, more preferably 1.2 to 6 μm from the standpoint of hard coat property, curl and fragility.

Examples of the binder for the light scattering layer may include preferably polymers having a saturated hydrocarbon chain or a polyether chain as a main chain. Among these polymers, the polymer having the saturated hydrocarbon chain as the main chain is more preferably used as the binder. The binder polymer has preferably a crosslinking structure. The binder polymer having the saturated hydrocarbon chain as the main chain is preferably a polymer of ethylenically unsaturated monomers. The binder polymer having the saturated hydrocarbon chain as the main chain and the crosslinking structure is preferably a (co)polymer of monomers each having two or more ethylenically unsaturated groups. To make a refractive index of the binder polymer high, at least one selected from aromatic ring, fluorine atom, halogen atom, sulpur atom, phosphorus atom and nitrogen atom may be optionally contained in a structure of the monomers.

Examples of the monomers having each having two or more ethylenically unsaturated groups may include ester of multi-valent alcohol and (math)acrylic acid (e.g., ethyleneglycoldi(math)acrylate, butanedioldi(math)acrylate, hexanedioldi(math)acrylate, 1,4-cyclohexanediacrylate, pentaerytritoltetra(math)acrylate, pentaerythritoltetra(math)acrylate, trimethylolpropanetri(math)acrylate, trimethylolethanetri(math)acrylate, dipentaerytritoltetra(math)acrylate, dipentaerytritolpenta(math)acrylate, dipentaerytritolhexa(math)acrylate, pentaerytritolhexa(math)acrylate, 1,2,3-cyclohexanetetramathacrylate, polyurethanepolyacrylate, and polyesterpolyacrylate), modified ethyleneoxide, vinylbenzene, and derivatives thereof (e.g., 1,4-divinylbenzene, 4-vinlybenzonic acid-2-acryloylethylester, and 1,4-divinylcyclohexanone), vinylsulfone (e.g., divinylsulfone), acrylamide (e.g., methylenebisacrylamide), and methacrylamide. The aforementioned monomers may be used in combination of two or more kinds.

Examples of the high refractive monomer may include bis(4-methacryloylthiopenyl)sulfide, vinylnaphthalene, vinylpenylsulfide, 4-methacryloxypenyl-4′-methoxypenylthioether, etc. These monomers may be used in combination of two or more kinds.

Polymerization of the monomers having the ethylenically unsaturated group may be conducted by ionizing radiation or heating under existence of radical photo initiator or radical thermal initiator.

Accordingly, a coating solution, which contains the monomer having the ethylenically unsaturated group, the radical photo initiator or the radical thermal initiator, the mat particles, and the inorganic filler, is prepared, and the coating solution is coated on a support and cured by polymerization reaction by ionizing radiation or heat to form the light scattering layer. As the radical photo initiator and so on, there may be used those known in the art.

The polymer having polyether as the main chain is preferably a ring-opening polymer of multifunctional epoxy compound. The ring-opening polymerization of multifunctional epoxy compound may be conducted by ionizing radiation or heating under existence of photo acid generator or thermal acid generator.

Accordingly, a coating solution, which contains the multifunctional epoxy compound, the photo acid generator or the thermal acid generator, the mat particles, and the inorganic filler, is prepared, and the coating solution is coated on a transparent support and cured by polymerization reaction by ionizing radiation or heat to form the antireflection layer.

Instead of or in addition to the monomer having two or more ethylenically unsaturated groups, a crosslinking functional group may be introduced into the polymer using a monomer having the crosslinking functional group, and a crosslinking structure may be introduced into the binder polymer by reaction of the crosslinking functional group.

Examples of the crosslinking functional group may include an isocyanate group, epoxy group, aziridine group, oxazoline group, aldehyde group, carbonyl group, hydrazine group, carboxyl group, methylol group and activated methylene group. Vinylsulfonic acid, acid anhydride, cyanoacrylate derivative, melamine, etherified methyol, ester, urethane, metal alkoxide such as tetramethoxysilane, and the like may be also used as the monomer to introduce the crosslinking structure. In addition, a crosslinking functional group obtained as a result of decomposition reaction, such as a block isocyanate group, may be used as the monomer. That is, in the invention, the crosslinking functional group may show reactivity as a result of decomposition reaction, not directly.

The binder polymer having the above crosslinking functional groups may form the crosslinking structure by being heated after being coated.

Mat particles, which are larger than filler particles and whose average diameter is 1 to 10 μm, preferably 1.5 to 7.0 μm, for example, inorganic compound particles or resin particles, are contained in the light scattering layer to give antiglare to the light scattering layer.

Examples of the mat particles may include inorganic compound particles such as silica particles, TiO₂ particles and the like, resin particles such as acryl particles, crosslinking acryl particles, polystyrene particles, crosslinking styrene particles, melamine resin particles, benzoguanimine resin particles and the like, etc. Among these particles, crosslinking styrene particles, crosslinking acryl particles, crosslinking acryl styrene particles and silica particles are preferably used as the mat particles. Shape of the mat particles may be either spherical or indefinite.

In addition, the mat particles may be used in combination of two or more kinds having different particle diameters. It is possible to give antiglare to the light scattering layer with mat particles having a larger particle diameter while giving a different optical characteristic to the light scattering layer with mat particles having a smaller particle diameter.

In addition, a particle diameter distribution of the mat particles is most preferably a mono-dispersed distribution. It is more preferable that the mat particles have same or more similar particle diameters. For example, assuming that particles having a particle diameter larger by more than 20% than an average particle diameter are coarse particles, a proportion of coarse particles is preferably less than 1%, more preferably less than 0.1%, even more preferably 0.01% of the total number of particles. The mat particles having such a particle diameter distribution can be obtained by classification after normal synthesis reaction. In this case, the matting agent having a more preferred particle diameter distribution can be obtained by increasing the number of classification or strengthening the degree of classification.

The mat particles are contained in the light scattering layer such that the amount of mat particles in the formed light scattering layer is preferably 10 to 1000 mg/m², more preferably 100 to 700 mg/m².

A granularity distribution of the mat particles is measured by a Coulter counter method, and the measured granularity distribution is converted to a particle number distribution.

In order to raise the refractive index of the light scattering layer, in addition to the mat particles, inorganic fillers, which are formed of oxide of at least one selected from titanium, zirconium, aluminum, indium, zinc, tin and antimony and have an average diameter of less than 0.2 μm, preferably 0.1 cm, more preferably 0.06 μm, are contained in the light scattering layer.

On the contrary, in the light scattering layer which contains high refractive index particles, in order to make a refractive index difference with the mat particles large, it is preferable to use silicon oxide to keep the refractive index of the layer low. A preferred particle diameter of silicon oxide is the same as that of the aforementioned inorganic fillers.

Examples of the inorganic fillers used for the light scattering layer may include metal oxides such as TiO₂, ZrO₂, Al₂O₂, In₂O₃, ZnO, SnO₂, Sb₂O₃, ITO, SiO₂, and so on. Among these metal oxides, TiO₂ and ZrO₂ are particularly preferable for high refractive index. Surfaces of the inorganic fillers are preferably subject to a silane coupling treatment or a titanium coupling treatment, and a surface treatment agent having a functional group that can react with binder species is preferably used for the filler surfaces.

The addition amount of the inorganic fillers is preferably 10 to 90 mass %, more preferably 20 to 80 mass %, particularly preferably 30 to 75 mass % for the overall mass of the light scattering layer.

Such inorganic fillers do not cause scattering since their diameter is sufficiently smaller than light wavelength, and dispersions obtained by dispersing the inorganic fillers in the binder polymer behave as optically uniform material.

A refractive index of a bulk of mixture of binder and inorganic fillers in the light scattering layer is preferably 1.48 to 2.00, more preferably 1.50 to 1.80. This range of refractive index may be attained when the kinds and amount ratio of binder and inorganic fillers are properly selected. How to select can be easily predetermined through experiment.

In the light scattering layer, one or both of a fluorine-based surfactant and a silicon-based surfactant is contained in the coating composition to avoid ununiformity of plane shape such as coating unevenness, dry unevenness, point defects and so on. In particular, the fluorine-based surfactant is preferably used since it exerts the effect of remedying plane faults such as coating unevenness, dry unevenness, point defects and so on even with less addition amount of surfactant. That is, the surfactant is used to increase productivity through high speed coating while raising uniformity of plane shape.

Next, the antireflection layer in which the medium refractive index layer, the high refractive index layer and the low refractive index layer are laminated in order will be described.

The antireflection layer having a layer structure of the medium refractive index layer, the high refractive index layer and the low refractive index layer (outermost layer) laminated in order on a base is designed to have a refractive index satisfying the following relationship.

Refractive index of high refractive index layer>refractive index of medium refractive index layer>refractive index of transparent support>refractive index of low refractive index layer

In addition, a hard coat layer may be provided between the transparent support and the medium refractive index layer. Further, a medium refractive index hard coat layer, a high refractive index layer and a low refractive index layer may be provided between the transparent support and the medium refractive index layer (for example, see JP-A-8-122504, JP-A-8-110401, JP-A-10-300902, JP-A-2002-243906, JP-A-2000-111706, etc.). In addition, different functions may be given to respective layers. For example, antifouling property may be given to the low refractive index layer, and antistatic property may be given to the high refractive index layer (for example, see JP-A-10-206603, JP-A-2002-243906, etc.).

Haze of the antireflection layer is preferably less than 5%, more preferably less than 3%. Film strength is preferably more than H, more preferably more than 2H, most preferably more than 3H in a pencil hardness test according to JIS K5400.

(High Refractive Index Layer and Medium Refractive Layer)

In the antireflection layer, a layer having a high refractive index is constituted by a curable film containing at least inorganic compound ultrafine particles, which have a high refractive index and an average diameter of less than 100 nm, and a matrix binder.

As the high refractive index inorganic compound ultrafine particles, there may be used inorganic compounds having a refractive index of more than 1.65, preferably more than 1.9. For example, the high refractive index inorganic compound ultrafine particles may include oxides of Ti, Zn, Sb, Sn, Zr, Ce, Ta, La, In and the like, complex oxides containing metal atoms thereof, etc.

Such high refractive index inorganic compound ultrafine particles may be prepared through a method of treating particle surfaces with a surface treatment agent (for example, a silane coupling agent or the like (see JP-A-11-295503, JP-A-11-153703 and JP-A-2000-9908), an anionic compound or organic metal coupling agent (see JP-A-2001-310432), a method of using a core shell structure having high refractive index particles as a core (see JP-A-2001-166104 and JP-A-2001-310432), a method of using a particular dispersing agent (see JP-A-11-153703, U.S. Pat. No. 6,210,858 and JP-A-2002-2776069).

As material for matrix, there may be used thermoplastic resin, curable resin and the like known in the art.

The matrix may include at least one of a multifunctional compound-containing composition having at least two radical and/or cation polymerizable groups and a composition which contains an organic metal compound having a hydrolytic group and partial condensate thereof. For example, as the matrix, there may be used compositions disclosed in JP-A-2000-47004, JP-A-2001-315242, JP-A-2001-31871, JP-A-2001-296401, etc.

In addition, as the matrix, there may be used a curable film obtainable from colloidal metal oxide and metal alkoxide composition which are obtainable from hydrolytic condensate of metal alkoxide, as disclosed in, for example, JP-A-2001-293818, etc.

A refractive index of the high refractive index layer is generally 1.70 to 2.20. Thickness of the high refractive index layer is preferably 5 nm to 10 μm, more preferably 10 nm to 1 μm.

A refractive index of the medium refractive index layer is adjusted to fall between refractive index of the low refractive index layer and refractive index of the high refractive index layer. The refractive index of the medium refractive index layer is preferably 1.50 to 1.70. Thickness of the medium refractive index layer is preferably 5 nm to 10 μm, more preferably 10 nm to 1 μm.

(Low Refractive Index Layer)

The low refractive index layer is laminated on the high refractive index layer. The refractive index of the low refractive index layer is 1.20 to 1.55, preferably 1.30 to 1.50.

The low refractive index layer is preferably constructed as the outermost layer having scratch resistance and antifouling. As means to greatly increase the scratch resistance, there may be used a thin film layer which can give slidability to a surface of the layer and is made of silicon or fluorine known in the art.

A refractive index of fluorine-containing compound is preferably 1.35 to 1.50, more preferably 1.36 to 1.47. The fluorine-containing compound is preferably a compound which contains a crosslinking or polymerizable functional group which contains fluorine atom in a range of 35 to 80 mass %.

For example, the fluorine-containing compound may be compounds disclosed in JP-A-9-222503, paragraphs [0018]-[0026], JP-A-11-38202, paragraphs [0019]-[0030], JP-A-2001-40284, paragraphs [0027]-[0028], JP-A-2000-284102, etc.

The silicon compound is preferably a compound which has a polysiloxane structure and contains a curable functional group or a polymerizable functional group in a polymer chain to have a crosslinking structure in the film. For example, the silicon compound may be reactive silicon (for example, silaplane (produced by CHISSO Corporation), polysiloxane which contains a silanol group in both ends (JP-A-11-258403), etc.

Crosslinking or polymerization reaction of fluorine-containing and/or siloxane polymer having a crosslining or polymerizable group is preferably conducted by light-radiating or heating a coat composition to form the outermost layer containing a polymerization initiator or a sensitizer when or after the coat composition is coated.

In addition, there may be preferably used a sol-gel curable film to be cured by condensation reaction of organic metal compound such as silane coupling agent and a fluorine-containing hydrocarbon group-containing silane coupling agent under coexistence of catalyst.

For example, the sol-gel curable film may be a polyfluoroalkyl group-containing silane compound or its partial hydrolytic condensate (compound disclosed in JP-A-58-142958, JP-A-58-147483, JP-A-58-147484, JP-A-9-157582, JP-A-11-106704, etc.), a silyl compound which contains a polyperfluoroalkylether group as a fluorine-containing long chain group (compound disclosed in JP-A-2000-117902, JP-A-2001-48590, JP-A-2002-53804, etc.), etc.

Besides, the low refractive index layer may contain a filler (for example, a low refractive inorganic compound having primary average diameter of 1 to 150 nm, such as silicon dioxide (silica) or fluorine-containing particles (magnesium fluoride, calcium fluoride or barium fluoride), organic corpuscles disclosed in JP-A-11-3820, paragraphs [0020]-[0038], etc.), a silane coupling agent, a lubricant, a surfactant, etc., as an additive.

If the low refractive index layer is located under the outermost layer, the low refractive index layer may be formed by a vapor method (vacuum deposition method, sputtering method, ion plating method, plasma CVD method, etc.). A coating method is preferably used in the aspect of product costs.

Film thickness of the low refractive index layer is preferably 30 to 200 nm, more preferably 50 to 150 nm, most preferably 60 to 120 nm.

(Other Layer in Antireflection Layer)

The antireflection layer may further include a hard coat layer, a forward scattering layer, a primer layer, an antistatic layer, an undercoat layer, a protective layer, etc.

(Hard Coat Layer)

The hard coat layer is provided on a surface of the protective film provided in the antireflection layer to give mechanical strength to the protective film. In particular, the hard coat layer is preferably provided between the protective film and the high refractive index layer. The hard coat layer is preferably formed by crosslinking reaction or polymerization reaction of light and/or thermal curable compound. A curable functional group is preferably a photopolymerizable functional group, and a hydrolytic functional group-containing organic metal compound is preferably an organic alkoxysilyl compound.

An example of this compound may include the same compounds as those contained in the high refractive index layer. Examples of composition of the hard coat layer may include those disclosed in JP-A-2002-144913, JP-A-2000-9908, WO 00/46617, etc.

The high refractive index layer may be also used as the hard coat layer. In this case, it is preferable to finely disperse corpuscles and contain the dispersed corpuscles in the hard coat layer using the method used for the high refractive index layer.

The hard coat layer may be also used as an antiglare layer to provide antiglare property by containing particles having an average diameter of 0.2 to 10 μm.

Film thickness of the hard coat layer may be designed depending on its use. The film thickness of the hard coat layer is preferably 0.2 to 10 μm, more preferably 0.5 to 7 μm.

Strength of the hard coat layer is preferably more than H, more preferably more than 2H, most preferably more than 3H in a pencil hardness test according to JIS K5400. In a taper test according to JIS K5400, less abrasion of test pieces before and after test.

(Antistatic Layer)

When an antistatic layer is provided, it is preferable to give volume resistivity of less than 10⁻⁸ (Ωcm⁻³) to the antistatic layer. Although it is possible to give volume resistivity of 10⁻⁸ (Ωcm⁻³) to the antistatic layer by use of absorptive material, aqueous inorganic salt, surfactant, cation polymer, anion polymer, colloidal silica, etc., there is a problem of great temperature/humidity dependency and insufficient conductivity at low humidity. On this account, metal oxide is preferably used as material of conductive layer. However, if colored metal oxide is used as material of conductive layer, it is not preferable since the colored metal oxide colors the entire film. Examples of metal for non-colored metal oxide may include Zn, Ti, Al, In, Si, Mg, Ba, Mo, W, V, etc., and it is preferable to use metal oxide having these metals as a main component. For example, the metal oxide includes preferably ZnO, TiO₂, SnO₂, Al₂O₃, In₂O₃, SiO₂, MgO, BaO, MoO₃, V₂O₅, etc., or complex oxide thereof, more preferably ZnO, TiO₂ and SnO₂. In the case where different atoms are contained, for example, it is effective that Al, In and the like are contained in ZnO, Sb, Nb, halogen atoms and the like are contained in SnO₂, and Nb, Ta and the like are contained in TiO₂. In addition, as disclosed in JP-A-59-6235, there may be used material in which the aforementioned metal oxide is attached to different crystalline metal particles or fibrous material (for example, titanium oxide). Although volume resistance can not be simply compared with surface resistance since they are different in physical property from each other, in order to secure conductivity of 10⁻⁸ (Ωcm⁻³) as volume resistivity, the conductive layer may have surface resistance of less than 10⁻¹⁰ (Ω/□), preferably less than 10⁻⁸ (Ω/□). The surface resistance of the conductive layer need be measured when the antistatic layer is the outermost layer, or may be measured during formation of the laminated film as described above.

[Liquid Crystal Display Device]

The polarizing plate using the optically-compensatory sheet of the invention can be used for liquid crystal cells and liquid crystal display devices having different display modes. There have been proposed various display modes including TN (Twisted Nematic), IPS (In-Plane Switching), FLC (Ferroelectric Liquid Crystal), AFLC (Anti-Ferroelectric Liquid Crystal), OCB (Optically Compensatory Bend), STN (Supper Twisted Nematic), VA (Vertically Aligned) and HAN (Hybrid Aligned Nematic). Among these modes, the polarizing plate of the invention can be preferably applied to TN, OCB and VA modes.

(OCB-Mode Liquid Crystal Display Device)

An OCB-mode liquid crystal cell is a liquid crystal device using a liquid cell of bend alignment mode in which rod-shaped liquid crystal molecules are aligned in a substantial reverse direction (symmetrically) in upper and lower portions of the liquid crystal cell. The OCB-mode liquid crystal cell is disclosed in, for example, U.S. Pat. No. 4,583,825 and U.S. Pat. No. 5,410,422. Since the rod-shaped liquid crystal molecules are aligned symmetrically in upper and lower portions of the liquid crystal cell, the liquid crystal cell of bend alignment mode has a self-optically-compensatory function. On this account, this liquid crystal mode is also called an OCB (Optically Compensatory Bend). A liquid crystal display device of bend alignment mode has an advantage of high speed response.

(VA-Mode Liquid Crystal Display Device)

In a VA-mode liquid crystal cell, rod-shaped liquid crystal molecules are substantially vertically aligned under no application of voltage.

The VA-mode liquid crystal cell includes (1) a narrow-sensed VA-mode liquid crystal cell in which rod-shaped liquid crystal molecules are substantially vertically aligned under no application of voltage and are substantially horizontally aligned under any application of voltage (as disclosed in JP-A-2-176625), (2) a liquid crystal cell (of MAV mode) having a multi-domain VA mode for extension of viewing angle (disclosed in SID97, Digest of tech. Papers (preview) 28 91997) 845), (3) a liquid crystal cell (of n-ASM mode) in which rod-shaped liquid crystal molecules are substantially vertically aligned under no application of voltage and are aligned in a twisted multi-domain under any application of voltage (as disclosed in Japan Liquid Crystal Conference Preview 58-59 (1998)), and (4) a SURVAIVAL-mode liquid crystal cell (published by LCD International 98).

The VA-mode liquid crystal display device includes a liquid crystal cell and two polarizing plates disposed at both sides of the liquid crystal cell. The liquid crystal cell carries liquid crystals between two electrode substrates. According to an aspect of the liquid crystal display device of the invention, one optically-compensatory sheet of the invention is interposed between the liquid crystal cell and one polarizing plate, or two optically-compensatory sheet of the invention are interposed between the liquid crystal cell and both polarizing plates, respectively.

According to another aspect of the liquid crystal display device of the invention, the optically-compensatory sheet of the invention is used as a transparent protective film of the polarizing plate interposed between the liquid crystal cell and the polarizer. The optically-compensatory sheet may be used only for the transparent protective layer (between the liquid crystal cell and the polarizer) of one polarizing plate, or may be used for two protective layers (between the liquid crystal cell and the polarizer) of both polarizing plates. When the optically-compensatory sheet is used only in one polarizing plate, it is particularly preferable to use the optically-compensatory sheet as a protective layer at a liquid crystal cell side of the polarizing plate at a backlight side of the liquid crystal cell. For bond of the optically-compensatory sheet to the liquid crystal cell, the base film of the cyclic olefin-based addition polymer of the invention is preferably at a VA cell side. The protective film may be a typical celluloseacylate film. For example, thickness of the protective film is 40 to 80 μm, and, as the protective film, there may be used KC4UX2M (40 μm, commercially available from Konica Minolta Opt Co., Ltd.), KC5UX (60 μm, commercially available from Konica Minolta Opt Co., Ltd.), TD80 (80 μm, commercially available from FUJIFILM Corporation), etc, without being limited thereto.

(TN-Mode Liquid-Crystal Display Device)

The optically-compensatory sheet of the invention may be used as a support for an optically-compensatory sheet of a TN-mode liquid-crystal display device having a TN-mode liquid-crystal cell. The TN-mode liquid-crystal cell and the TN-mode liquid-crystal display device have long been well known. For details, reference can be made to JP-A-3-9325, JP-A-6-148429, JP-A-8-50206, and JP-A-9-26572. In addition, reference can be also made to Mori et al.'s papers (Jpn. J. Appl. Phys., Vol. 36 (1997), p. 143; Jpn. J. Appl. Phys., Vol. 36 (1997), p. 1068).

### EXAMPLE

The invention will be further described in the following examples, but the invention is not limited thereto.

The term “parts” as used hereinafter is meant to indicate “parts by mass.”

[Measuring Method]

The film was measured for properties by the following methods.

(Retardation)

In the specification, Re(λ) and Rth(λ) indicate retardation in in-plane retardation and thickness-direction retardation at a wavelength of λ respectively. Using KBRA 21ADH or WR (produced by Ouji Scientific Instruments Co., Ltd.), Re(λ) is measured by light having a wavelength of λ nm incident thereon in the direction normal to the film. Using KOBRA 21ADH or WR, Rth is then calculated on the basis of six retardation values measured in six directions, i.e., Re measured in the direction normal to the film, Re measured in the direction of +50° from the direction of normal to the film with in-plane slow axis (judged by KOBRA 21ADH) as axis of tilt (axis of rotation) and Re measured in the direction of −50° from the direction of normal to the film with in-plane slow axis (judged by KOBRA 21ADH) as axis of tilt (axis of rotation). Based on the retardation values measured in two directions with the slow axis as a tilt axis (with any direction in the film as an rotation axis in case of no slow axis), a hypothetical value of an average refractive index, and film thickness, Rth can be calculated from the following equations (1) and (2). For the hypothetical value of average refractive index, reference can be made to “Polymer Handbook,” JOHN WILEY & SONS, INC. and catalogues of optical films. For those having unknown average refractive index values, an Abbe refractomter can be used. The average refractive index of main optical films are exemplified as follows: celluloseacylate (1.48), cycloolefin polymer (1.52), polycarbonate (1.59), polymethylmethacrylate (1.49), polystyrene (1.59). By inputting these hypothetical values of average refractive index and film thickness, KOBRA 21ADH or WR calculates nx, ny and nz. Nz (=(nx−nz)/(nx−ny)) is further calculated based on the calculated nx, ny and nz. Equation 1

$$Re ( θ ) = [ nx - \frac{( ny \times nz )}{\sqrt{\begin{matrix} {\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{6}\end{matrix}}} ] \times \frac{d}{cos \{ {sin}^{- 1} ( \frac{sin ( - θ )}{nx} ) \}} \qquad Equation 1$$

Note: in the above equation, Re(λ) represents retardation in a direction inclined by θ from the normal direction.
Rth=((nx+nz)/2−nz)xd Equation 2
(Water Content)

Using a Type CA-03 water content measuring instrument and a Type VA-05 sample dryer (both produced by Mitsubishi Chemical Corporation), a sample having a size of 7 mm×35 mm is measured by Karl Fischer titration. The water content is calculated by dividing the water content (g) by the mass (g) of the sample.

(Dynamic Friction Coefficient)

Dynamic friction coefficient may be measured using a steel ball according to the method specified by JIS or ASTM.

(Haze)

Haze may be measured using a 1001DP type haze meter (available from Nippon Denshoku Industries Co., Ltd.).

(Peeling Resistance)

The peeling load is measured as follows. A dope is dropped on a metal plate having the same material and surface roughness as the metal support of the film formation apparatus, and then the dope is stretched at a uniform thickness using a doctor blade and is dried to form a film. The resultant film is inscribed in a stripe shape at equal intervals using a cutter knife. Then, a leading edge of the film is peeled off by hand, and, with the film fixed by a clip connected to a strain gauge, change of load of the film is measured while pulling up the strain gauge with an inclination of 45° C. The amount of volatile component in the peeled film is also measured. The same measurement is repeated several times while changing dry time, and a peeling load when the amount of volatile component is equal to the amount of remaining volatile component in peeling of the film in an actual film formation process. The peeling load is measured using the dope for film formation prepared in the following Examples, and peeling resistance per 1 cm of film width is calculated and listed in Table 1.

### Example 1

### Formation of Base Film

(Formation of Base Film F-11 of Cyclic Olefin-Based Addition Polymer)

APL5014 (Tg: 135° C.) (produced by Mitsui Chemicals, Inc.) was melted in a monoaxial extruder having an inner diameter of 50 mm and L/D of 28 while being preheated to 90° C. The temperature of the extruder was 200° C. at the inlet side thereof and 140° C. at the outlet side thereof. The molten film material was then extruded through T-die via sintering filter a gear pump at the outlet of the extruder.

Three cold rolls were used at the cooling step. These cold rolls were disposed at an interval of 3 cm. The temperature of the first cold roll, which is disposed closest to the die, was 130° C. The value obtained by subtracting the temperature of the first cold roll from that of the second cold roll was 3° C. The value obtained by subtracting the temperature of the third cold roll from that of the second cold roll was 13° C.

The ratio (ΔSr₂₁(%)=100×(Sr₂−Sr₁)/Sr₁) of the difference between the conveying speed (Sr2) of the second cold roll and the conveying speed (Sr1) of the first cold roll to the conveying speed of these rolls (conveying speed (Sr1=50 m/min) of the first cold roll) was 1%. The ratio (ΔSr₂₃(%)=100×(Sr₂−Sr₃)/Sr₂) of the difference between the conveying speed (Sr3) of the third cold roll and the conveying speed (Sr2) of the second cold roll to the conveying speed (Sr2) of the second roll was 1%. These cold rolls were all disposed in a 120° C. casing. Using an electrostatic application method, the sheet was pressed against the first cold roll over a width of 0.17 m portion of the sheet width of 1.7 m.

The cooling rate between these cold rolls disposed close to each other was 2° C./sec. The cooling rate was represented by the value calculated by dividing the difference between the temperature of the film disposed on the first cold roll and the temperature of the film peeled off the final cold roll by the time required for the film to pass through the zone.

The film which had been peeled off the final cold roll was then conveyed over rolls disposed at an interval of 0.5 m at a cooling rate of 2° C./sec. The film thus obtained had a thickness of 79 μm. Thereafter, the film was laminated with another film, trimmed by 10% at both edges thereof (slit), and then wound in a length of 3,000 m. As measured by KOBRA 21ADH (produced by Ouji Scientific Instruments Co., Ltd.), the film (F-1) showed an in-plane retardation Re of 1 nm and a thickness-direction retardation Rth of 4 nm.

(Formation of Base Film F-21 of Cyclic Olefin-Based Addition Polymer)

<Synthesis of Cyclic Polyolefin Polymer P-1>

100 parts by mass of purified toluene and 100 parts by mass of methyl ester norbornenecarboxylate were charged in a reaction vessel. Subsequently, nickel ethylhexanoate dissolved in toluene, tri(pentafluorophenyl) boron and triethyl aluminum dissolved in toluene were charged in the reaction vessel in an amount of 25 mmol % (based on the mass of monomer), 0.225 mol % (based on the mass of monomer) and 0.25 mol % (based on the mass of monomer), respectively. These components were then reacted at room temperature with stirring for 18 hours. After the termination of reaction, the reaction mixture was then put in excess ethanol to cause the production of a copolymer precipitate. The precipitate was purified. The resulting copolymer (P-1) was then dried in vacuo at 65° C. for 24 hours.

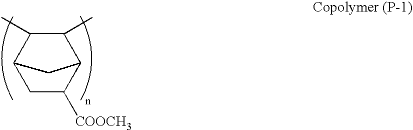

The following compositions were charged in a mixing tank where they were then stirred for dissolution. The solution was then filtered through a filter paper having an average pore diameter of 34 μm and a sintered metal filter having an average pore diameter of 10 μm.

TABLE 1

| Cyclic olefin-based addition polymer solution | |
|---|---|
| Cyclic olefin-based addition polymer P-1 | 150 parts by mass |
| Methylene chloride | 400 parts by mass |
| Methanol | 50 parts by mass |

Subsequently, the following composition containing a cyclic polyolefin solution prepared by the aforementioned method was charged in a dispersing machine to prepare a matting agent dispersion.

TABLE 2
Matting agent dispersion

| | |
|---|---|
| Particulate silica having average particle diameter of | 2.0 parts by mass |
| 16 nm (Aerosil R972, produced by NIPPON | |
| AEROSIL CO., LTD.) | |
| Methylene chloride | 72.4 parts by mass |
| Methanol | 10.8 parts by mass |
| Cyclic olefin-based addition polymer solution | 10.3 parts by mass |

100 parts by mass of the aforementioned cyclic olefin-based addition polymer solution and 1.35 parts by mass of the aforementioned matting agent dispersion were then mixed to prepare a dope for film formation.

The dope was cast using a band caster. A film which was peeled off from the band at the time when the remaining solvent amount was from 15% to 25% by mass was stretched in the width direction at a stretching ratio of 2% using a tenter and was dried by hot air of 120° C. while being held so that the film would not be wrinkled. After being conveyed by the tenter, the film was further conveyed by a roll, and was further dried at 120° C. to 140° C. and wound up. Characteristics of the prepared film (F-21) are shown in Table 1.

(Formation of Base Films F-31 and F-41 of Cyclic Olefin-Based Addition Polymer)

Using the following compositions, dopes was formed in the same manner as Film F-21.

TABLE 3

| Cyclic olefin-based addition polymer solution | |
|---|---|
| Appear 3000 | 150 parts by mass |
| Methylene chloride | 420 parts by mass |
| Methanol | 30 parts by mass |

TABLE 4
Matting agent dispersion

| | |
|---|---|
| Particulate silica having average particle diameter of | 2.0 parts by mass |
| 16 nm (Aerosil R972, produced by NIPPON | |
| AEROSIL CO., LTD.) | |
| Methylene chloride | 77.6 parts by mass |
| Methanol | 5.6 parts by mass |
| Cyclic olefin-based addition polymer solution | 10.3 parts by mass |

Films F-31 and F-41 were formed in the same manner as Film F-21.

(Formation of Base Film F-5 of Cyclic Olefin-Based Addition Polymer)

Using the following compositions, dopes was formed in the same manner as Film F-21.

TABLE 5

| Cyclic olefin-based addition polymer solution | |
|---|---|
| Appear 3000 | 150 parts by mass |
| Methylene chloride | 410 parts by mass |
| Methanol | 40 parts by mass |

TABLE 6
Matting agent dispersion

| | |
|---|---|
| Particulate silica having average particle diameter of | 2.0 parts by mass |
| 16 nm (Aerosil R972, produced by NIPPON | |
| AEROSIL CO., LTD.) | |
| Methylene chloride | 78.0 parts by mass |
| Methanol | 5.0 parts by mass |
| Cyclic olefin-based addition polymer solution | 10.0 parts by mass |

Film F-51 was formed in the same manner as Film F-21.

(Formation of Base Film F-6 of Cyclic Olefin-Based Addition Polymer)

Using the following compositions, dopes was formed in the same manner as Film F-21.

TABLE 7

| Cyclic olefin-based addition polymer solution | |
|---|---|
| Appear 3000 | 150 parts by mass |
| Methylene chloride | 450 parts by mass |

TABLE 8
Matting agent dispersion

| | |
|---|---|
| Particulate silica having average particle diameter of | 2.0 parts by mass |
| 16 nm (Aerosil R972, produced by NIPPON | |
| AEROSIL CO., LTD.) | |
| Methylene chloride | 83.0 parts by mass |
| Cyclic olefin-based addition polymer solution | 10.0 parts by mass |

Film F-61 was formed in the same manner as Film F-21.

Characteristics of the base films of the cyclic olefin-based addition polymers of Examples F-11 to F-51 and Comparative Example F-61 are shown in the following Table 9.

TABLE 9

| | | | Peeling | | Film | Dynamic | | | |
|---|---|---|---|---|---|---|---|---|---|
| | | Peeling | resistance | Stretching | thickness | friction | | Re | Rth |
| No. | Polymer | agent | N/cm | ratio % | μm | coefficient | Haze % | nm | nm |
| F-11 | APL5014 | — | — | — | 79 | 0.4 | 0.42 | 1 | 4 |
| F-21 | P-L | methanol | 0.01 | 2 | 61 | 0.4 | 0.40 | 11 | 216 |
| F-31 | Appear | | 0.20 | 10 | 55 | 0.5 | 0.30 | 42 | 215 |
| F-41 | 3000 | | 0.21 | 2 | 40 | 0.5 | 0.28 | 6 | 150 |
| F-51 | | RZ-I3 | 0.02 | 2 | 50 | 0.4 | 0.25 | 8 | 185 |
| F-61 | | — | 0.85 | 2 | 40 | 0.5 | 0.16 | 8 | 150 |

### Example 2

### Surface Treatment of Base Film of Cyclic Olefin-Based Addition Polymer

The base films F-11, F-21, F-31, F-41, F-51 and F-61 of cyclic olefin-based addition polymer were each subjected to glow discharge treatment (a high frequency voltage of 4,200 V having a frequency of 3,000 Hz is applied across upper and lower electrodes for 20 seconds) between upper and lower brass electrodes (in an argon gas atmosphere) to prepare films F-12, F-22, F-32, F-42, F-52 and F-62. The surface of the protective films which had thus been subjected to glow discharge treatment showed a contact angle of from 36° to 41° with respect to purified water. For the measurement of contact angle, a Type CA-X contact angle meter (produced by Kyowa Interface Science Co., Ltd.) was used.

### Example 3-1

### Preparation of Optically-Compensatory Sheet L-31

(Formation of Oriented Film)

A coating solution having the following formulation was spread over the base film F-31 of cyclic olefin-based addition polymer at a rate of 24 mL/m² using a #14 wire bar coater. The coated material was dried with hot air of 60° C. for 60 seconds and then with hot air of 90° C. for 150 seconds. Subsequently, the film thus formed was subjected to rubbing in the direction of 135° deviated clockwise from the longitudinal direction of the base film of cyclic olefin-based addition polymer (conveying direction) as 0°.

(Formulation of oriented film coating solution)

| | | |
|---|---|---|
| Modified polyvinyl alcohol having the following formula | 40 | parts by mass |
| Water | 728 | parts by mass |
| Methanol | 228 | parts by mass |
| Glutaraldehyde (crosslinking agent) | 2 | parts by mass |
| Citric acid ester (AS3, produced by Sankyo Chemical Co., Ltd.) | 0.69 | parts by mass |
| Modified polyvinyl alcohol | | |
| 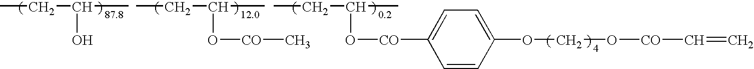 | | |

(Formation of Optically Anisotropic Layer)

A coating solution obtained by dissolving 41.01 kg of the following discotic liquid crystal compound, 4.06 kg of an ethylene oxide-modified trimethylolpropane triacrylate “V#360” (produced by OSAKA ORGANIC CHEMICAL INDUSTRY LTD.), 0.29 kg of cellulose acetate butyrate “CAB531-1” (produced by Eastman Kodak Inc.), 1.35 kg of a photopolymerization initiator “Irgacure 907” (produced by Ciba Specialty Chemicals Co., Ltd.), 0.45 kg of a sensitizer “Kayacure DETX” (produced by Nippon Kayaku Corporation) and 0.45 kg of citric acid ester “AS3” (produced by Sankyo Chemical Co., Ltd.) in 102 kg of methyl ethyl ketone, and then adding 0.1 kg of a fluoroaliphatic group-containing copolymer “Megafac F780” (produced by DAINIPPON INK AND CHEMICALS, INCORPORATED) was continuously spread over Film F-32 which was being conveyed at a rate of 20 m/min using a #2.7 wire bar which was being rotated at 391 rpm in the same direction as the conveying direction of the film. The film was then dried at a step where it was heated continuously from room temperature to 100° C. so that the solvent was removed. Thereafter, the film was dried in a 135° C. drying zone in such a manner that the speed of wind which hits the surface of the discotic liquid crystal compound layer was 1.5 m/sec parallel to the conveying direction of the film for about 90 seconds so that the discotic liquid crystal compound was aligned. Subsequently, while being conveyed through a 80° C. drying zone, the film was irradiated with ultraviolet rays at a dose of 600 mW from an ultraviolet emitter (ultraviolet lamp: output: 160 W/cm; wavelength: 1.6 m) with the surface temperature of the film kept at about 100° C. for 4 seconds to cause the progress of crosslinking reaction so that the discotic liquid crystal compound was fixed aligned. Thereafter, the film was allowed to cool to room temperature, and then wound up in a cylindrical form to form a roll. Thus, a rolled optically anisotropic optically-compensatory sheet L32 was prepared. The optically anisotropic layer thus formed had a thickness of 1.6 μm.
Discotic Liquid Crystal Compound

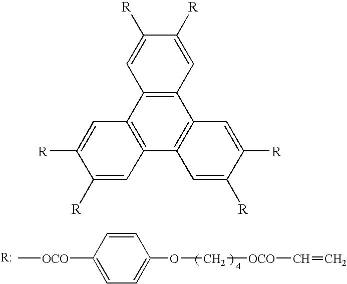

The optically anisotropic layer showed Re of 27 nm as measured by a Type KOBRA 21ADH automatic birefringence measuring instrument (produced by Ouji Scientific Instruments Co., Ltd.). Only the optically anisotropic layer was then peeled off the optically-compensatory sheet thus prepared. The optically anisotropic layer was then measured for β value and average direction of molecular asymmetric axis using a Type KOBRA 21ADH automatic birefringence measuring instrument (produced by Ouji Scientific Instruments Co., Ltd.). As a result, β value was 33°. The average direction of molecular asymmetric axis was 45.5° with respect to the longitudinal direction of the base cyclic olefin-based addition polymer film. For the calculation of β value, 1.6 was inputted as an average refractive index.

### Example 3-2

### Optically-Compensatory Sheets L12 and L42

An oriented film was formed on the films F-12 and F-42 which had been subjected to glow discharge treatment in the same manner as in Example 3-1. Subsequently, the oriented film thus formed was subjected to rubbing in the direction of 180° deviated clockwise from the longitudinal direction of the film (conveying direction) as 0°.

A coating solution obtained by dissolving 91.0 kg of the aforementioned discotic liquid crystal compound, 9.0 kg of an ethylene oxide-modified trimethylolpropane triacrylate “V#360” (produced by OSAKA ORGANIC CHEMICAL INDUSTRY LTD.), 2.0 k of cellulose acetate butyrate “CAB551-0.2” (produced by Eastman Kodak Inc.), 0.5 kg of cellulose acetate butyrate “CAB531-1” (produced by Eastman Kodak Inc.), 3.0 kg of a photopolymerization initiator “Irgacure 907” (produced by Ciba Specialty Chemicals Co., Ltd.) and 1.0 kg of a sensitizer “Kayacure DETX” (produced by Nippon Kayaku Corporation) in 207 kg of methyl ethyl ketone, and then adding 0.4 kg of a fluoroaliphatic group-containing copolymer “Megafac F780” (produced by DAINIPPON INK AND CHEMICALS, INCORPORATED) was continuously spread over the oriented film which was being conveyed at a rate of 20 m/min using a #3.2 wire bar which was being rotated at 391 rpm in the same direction as the conveying direction of the film.

The film was then dried at a step where it was heated continuously from room temperature to 100° C. so that the solvent was removed. Thereafter, the film was dried in a 135° C. drying zone in such a manner that the speed of wind which hits the surface of the discotic liquid crystal compound layer was 5.0 m/sec parallel to the conveying direction of the film for about 90 seconds so that the discotic liquid crystal compound was aligned. Subsequently, while being conveyed through a 80° C. drying zone, the film was irradiated with ultraviolet rays at a dose of 600 mW from an ultraviolet emitter (ultraviolet lamp: output: 160 W/cm; wavelength: 1.6 m) with the surface temperature of the film kept at about 100° C. for 4 seconds to cause the progress of crosslinking reaction so that the discotic liquid crystal compound was fixed aligned. Thereafter, the film was allowed to cool to room temperature, and then wound up in a cylindrical form to form a roll. Thus, rolled optically anisotropic optically-compensatory sheets L12 (base film: F-12) and L42 (base film: F-42) were prepared. The optically anisotropic layer thus formed had a thickness of 1.9 μm.

The optically anisotropic layer showed Re of 46 nm as measured by a Type KOBRA 21ADH automatic birefringence measuring instrument (produced by Ouji Scientific Instruments Co., Ltd.). Only the optically anisotropic layer was then peeled off the optically-compensatory sheet thus prepared. The optically anisotropic layer was then measured for β value and average direction of molecular asymmetric axis using a Type KOBRA 21ADH automatic birefringence measuring instrument (produced by Ouji Scientific Instruments Co., Ltd.). As a result, β value was 38°. The average direction of molecular asymmetric axis was −0.3° with respect to the longitudinal direction of the base cyclic olefin-based addition polymer film. For the calculation of β value, 1.6 was inputted as an average refractive index.

### Example 3-3

### Optically-Compensatory Sheets L13, L23 and L53

The following acrylic acid copolymer and triethylamine (neutralizing agent) were dissolved in a 30/70 (by mass) mixture of methanol and water to prepare a 4 mass % solution. Using a bar coater, the solution was then continuously spread over the glow-discharged base films F-12, F-22 and F-52 of cyclic olefin-based addition polymer which were being conveyed. The coat layer was then heated and dried to 120° C. for 5 minutes to form a 1 μm thick layer. Subsequently, the surface of the coat layer was continuously subjected to rubbing in the longitudinal direction (conveying direction) to form an oriented film.
Acrylic Acid Copolymer

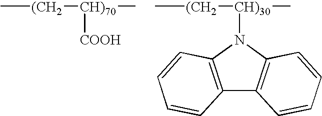

A coating solution having the following formulation was continuously spread over the aforementioned oriented film using a bar coater. The coat layer was heated to 100° C. for 1 minute to align rod-shaped liquid crystal molecules, and then irradiated with ultraviolet rays to cause the polymerization of rod-shaped liquid crystal molecules so that the liquid crystal molecules were fixed aligned to prepare optically-compensatory sheets L13, L23 and L53 (base film: F-12, F-22 and F-52, respectively). The optically anisotropic layer thus formed had a thickness of 1.7 μm.

TABLE 10
Formulation of coating solution of optically anisotropic layer

| | |
|---|---|
| Rod-shaped liquid crystal compound having the | 38.4% by mass |
| following formula | |
| Sensitizer having the following formula | 0.38% by mass |
| Photopolymerization initiator having the following | 1.15% by mass |
| formula | |
| Air interface horizontal alignment agent having the | 0.06% by mass |
| following formula | |
| Methyl ethyl ketone | 60.0% by mass |

Rod-Shaped Liquid Crystal Compound 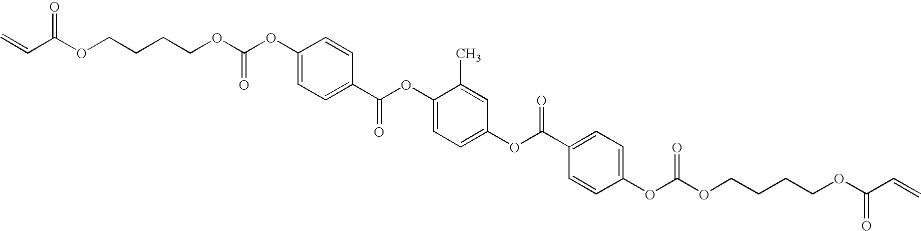
Sensitizer 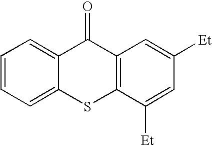
Photopolymerization Initiator 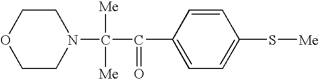
Air Interface Horizontal Alignment Agent

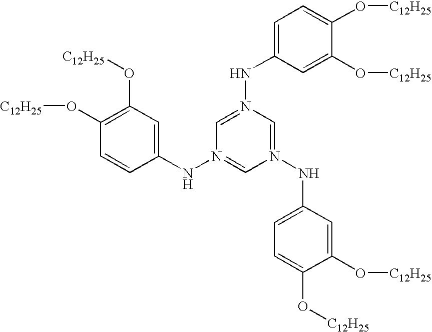

The contribution of the base film of cyclic olefin-based addition polymer which had been previously measured was subtracted from the dependence of the optically-compensatory sheets L13 and L23 on the angle of incidence of light measured using a Type KOBRA 21ADH automatic birefringence measuring instrument (produced by Ouji Scientific Instruments Co., Ltd.) to calculate the optical characteristics of the optically anisotropic layer alone. As a result, Re was 47 nm, Rth was 23 nm, and the average angle of tilt of the major axis of the rod-shaped liquid crystal molecules with respect to the surface of the layer was 0°. The rod-shaped liquid crystal molecules were observed aligned parallel to the surface of the film. The rod-shaped liquid crystal molecules were aligned such that the major axis thereof was orthogonal to the longitudinal direction of the base film of the rolled cyclic olefin-based addition polymer (i.e., the direction of the slow axis of the optically anisotropic layer was orthogonal to the longitudinal direction of the base film of the rolled cyclic olefin-based addition polymer.)

The optically-compensatory sheet (L13) thus obtained had Re of 48 nm and Rth (measured at a wavelength of 590 nm) of 27 nm. On the other hand, the optically-compensatory sheet (L23) had Re of 58 nm and Rth (measured at a wavelength of 590 nm) of 239 nm.

### Example 3-4

### Optically-Compensatory Sheet L24

A polyimide (mass-average molecular mass: 59,000) synthesized from 2,2′-bis(3,4-dicarboxy diphenyl)hexafluoropropane and 2,2′-bis(trifluoromethyl)-4,4′-diaminobiphenyl was dissolved in cyclohexanone to prepare a 15 mass % polyimide solution. The polyimide solution thus prepared was spread over the glow-discharged cyclic polyolefin film F-22, and then dried at a temperature of 180° C. The optically-compensatory sheet L24 had a total thickness of 59 μm, Re of 45 nm and Rth of 390 nm.

### Example 4-1

### Formation of Polarizing Plate A

(Preparation of Light-Scattering Layer Coating Solution)

50 g of a mixture of pentaerythritol triacrylate and pentaerythritol tetraacrylate (PETA, produced by Nippon Kayaku Corporation) was diluted with 38.5 g of toluene. To the solution was then added 2 g of a polymerization initiator (Irgacure 184, produced by Ciba Specialty Chemicals Co., Ltd.). The mixture was then stirred. The coat layer obtained by spreading this solution and ultraviolet-curing the coat had a refractive index of 1.51.

To this solution were then added 1.7 g of a 30% toluene dispersion of a particulate crosslinked polystyrene having an average particle diameter of 3.5 μm (refractive index: 1.60; SX-350, produced by Soken Chemical & Engineering Co., Ltd.) which had been dispersed at 10,000 rpm using a polytron dispersing machine for 20 minutes and 13.3 g of a 30% toluene dispersion of a particulate crosslinked acryl-styrene having an average particle diameter of 3.5 μm (refractive index: 1.55; produced by Soken Chemical & Engineering Co., Ltd.). Eventually, to the mixture were then added 0.75 g of a fluorine-based surface modifier (FP-1) and 10 g of a silane coupling agent (KBM-5103, produced by Shin-Etsu Chemical Co., Ltd.) to obtain a finished solution.

The aforementioned mixture was then filtered through a polypropylene filter having a pore diameter of 30 μm to prepare a light-scattering layer coating solution.
Fluorine-Based Surface Modifier (FP-1) 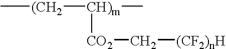
wherein m represents a number of about 36; and n represents a number of 6.
(Preparation of Low Refractive Index Layer Coating Solution)

A sol a was first prepared in the following manner. In some detail, 120 parts of methyl ethyl ketone, 100 parts of an acryloyloxypropyl trimethoxysilane (KBM5103, produced by Shin-Etsu Chemical Co., Ltd.) and 3 parts of diisopropoxyaluminum ethyl acetoacetate were charged in a reaction vessel equipped with an agitator and a reflux condenser to make mixture. To the mixture were then added 30 parts of deionized water. The mixture was reacted at 60° C. for 4 hours, and then allowed to cool to room temperature to obtain a sol a. The mass-average molecular mass of the sol was 1,600. The proportion of components having a molecular mass of from 1,000 to 20,000 in the oligomer components was 100%. The gas chromatography of the sol showed that no acryloyloxypropyl trimethoxysilane which is a raw material had been left.

13 g of a thermally-crosslinkable fluorine-containing polymer (JN-7228; solid concentration: 6%; produced by JSR Co., Ltd.) having a refractive index of 1.42, 1.3 g of silica sol (silica having a particle size different from that MEK-ST; average particle size: 45 nm; solid concentration: 30%; produced by NISSAN CHEMICAL INDUSTRIES, LTD.), 0.6 g of the sol a thus prepared, 5 g of methyl ethyl ketone and 0.6 g of cyclohexanone were mixed with stirring. The solution was then filtered through a polypropylene filter having a pore diameter of 1 μm to prepare a low refractive index layer coating solution.

(Preparation of Protective Layer TAC01 Having Light-Scattering Layer)

The aforementioned coating solution for functional layer (light-scattering layer) was spread over a triacetyl cellulose film having a thickness of 80 μm (Fujitac TD80U, produced by Fuji Photo Film Co., Ltd.) which was being unwound from a roll at a gravure rotary speed of 30 rpm and a conveying speed of 30 m/min using a microgravure roll with a diameter of 50 mm having 180 lines/inch and a depth of 40 μm and a doctor blade. The coated film was dried at 60° C. for 150 seconds, irradiated with ultraviolet rays at an illuminance of 400 mW/cm² and a dose of 250 mJ/cm² from an air-cooled metal halide lamp having an output of 160 W/cm (produced by EYE GRAPHICS CO., LTD.) in an atmosphere in which the air within had been purged with nitrogen so that the coat layer was cured to form a functional layer to a thickness of 6 μm. The film was then wound up.

The coating solution for low refractive index layer thus prepared was spread over the triacetyl cellulose film having a functional layer (light-scattering layer) provided thereon which was being unwound at a gravure rotary speed of 30 rpm and a conveying speed of 15 m/min using a microgravure roll with a diameter of 50 mm having 180 lines/inch and a depth of 40 μm and a doctor blade. The coated film was dried at 120° C. for 150 seconds and then at 140° C. for 8 minutes. The film was irradiated with ultraviolet rays at an illuminance of 400 mW/cm² and a dose of 900 mJ/cm² from an air-cooled metal halide lamp having an output of 240 W/cm (produced by EYE GRAPHICS CO., LTD.) in an atmosphere in which the air within had been purged with nitrogen to form a low refractive index layer to a thickness of 100 μm. The film was then wound up.

Using a spectrophotometer (produced by JASCO CO., LTD.), the polarizing plate was measured for spectral reflectance on the functional layer side thereof at an incidence angle of 5° and a wavelength of from 380 to 780 nm to determine an integrating sphere average reflectance at 450 to 650 nm. As a result, the polarizing plate exhibited an integrating sphere average reflectance of 2.3%.

(Preparation of Polarizing Plate A)

Iodine was adsorbed to the polyvinyl alcohol film thus stretched to prepare a polarizer.

The surface of the transparent protective layer TAC01 with light-scattering layer thus prepared was then subjected to alkaline saponification. The transparent protective layer thus saponified was stuck to one side of the polarizer on the side thereof opposite the functional layer with a polyvinyl alcohol-based adhesive.

The optically-compensatory sheets (L12, L13, L23, L24, L32, L42 and L53) prepared in Examples 3-1 to 3-4 were each subjected to glow discharge treatment (a high frequency voltage of 4,200 V having a frequency of 3,000 Hz is applied across upper and lower electrodes for 20 seconds), stuck to the opposite side of the polarizing plate on the base film side thereof with a polyvinyl alcohol-based adhesive, and then dried at 70° C. for 10 minutes or more.

Arrangement was made such that the transmission axis of the polarizer and the slow axis of the optically-compensatory sheets prepared in Examples 3-1 to 3-4 were disposed parallel to each other and the transmission axis of the polarizer and the slow axis of the transparent protective layer TAC01 with light-scattering layer were disposed perpendicular to each other. Thus, polarizing plates (A-12, A-13, A-23, A-24, A-31, A-42 and A-53) were prepared.

### Example 4-2

### Formation of Polarizing Plate B

(Preparation of Hard Coat Layer Coating Solution)

To 750.0 parts by mass of a trimethylolpropane triacrylate (TMPTA, produced by NIPPON KAYAKU CO., LTD.) were added 270.0 parts by mass of a poly(glycidyl methacrylate) having a mass-average molecular mass of 3,000, 730.0 g of methyl ethyl ketone, 500.0 g of cyclohexanone and 50.0 g of a photopolymerization initiator (Irgacure 184, produced by Ciba Geigy Japan Inc.). The mixture was then stirred. The mixture was then filtered through a polypropylene filter having a pore diameter of 0.4 μm to prepare a hard coat layer coating solution.

(Preparation of Fine Dispersion of Particulate Titanium Dioxide)

As the particulate titanium dioxide there was used a particulate titanium dioxide containing cobalt surface-treated with aluminum hydroxide and zirconium hydroxide (MPT-129, produced by ISHIHARA SANGYO KAISHA, LTD.).

To 257.1 g of the particulate titanium dioxide were then added 38.6 g of the following dispersant and 704.3 g of cyclohexanone. The mixture was then dispersed using a dinomill to prepare a dispersion of titanium dioxide particles having a mass-average particle diameter of 70 nm.
Dispersant 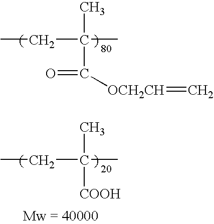
(Preparation of Middle Refractive Index Layer Coating Solution)

To 88.9 g of the aforementioned dispersion of titanium dioxide particles were added 58.4 g of a mixture of dipentaerytritol petaacrylate and dipentaerythritol hexaacrylate (DPHA), 3.1 g of a photopolymerization initiator (Irgacure 907), 1.1 g of a photosensitizer (Kayacure DETX, produced by NIPPON KAYAKU CO., LTD.), 482.4 g of methyl ethyl ketone and 1,869.8 g of cyclohexanone. The mixture was then stirred. The mixture was thoroughly stirred, and then filtered through a polypropylene filter having a pore diameter of 0.4 μm to prepare a middle refractive index layer coating solution.

(Preparation of High Refractive Layer Coating Solution)

To 586.8 g of the aforementioned dispersion of titanium dioxide particles were added 47.9 g of a mixture of dipentaerytritol petaacrylate and dipentaerythritol hexaacrylate (DPHA, produced by Nippon Kayaku Corporation), 4.0 g of a photopolymerization initiator (Irgacure 907, produced by Ciba Specialty Chemicals Co., Ltd.), 1.3 g of a photosensitizer (Kayacure DETX, produced by NIPPON KAYAKU CO., LTD.), 455.8 g of methyl ethyl ketone and 1,427.8 g of cyclohexanone. The mixture was then stirred. The mixture was then filtered through a polypropylene filter having a pore diameter of 0.4 μm to prepare a high refractive index layer coating solution.

(Preparation of Low Refractive Index Layer Coating Solution)

A copolymer represented by the following formula was dissolved in methyl ethyl ketone in such an amount that the concentration reached 7% by mass. To the solution were then added a methacrylate group-terminated silicone resin X-22-164C (produced by Shin-Etsu Chemical Co., Ltd.) and a photoradical generator Irgacure 907 (trade name) in an amount of 3% and 5% by mass, respectively, to prepare a low refractive layer coating solution.
Copolymer

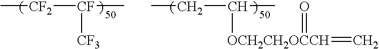

(50:50 indicates molar ratio)

(Preparation of Transparent Protective Layer Tac02 Having Anti-Reflection Layer)

A hard coat layer coating solution was spread over a triacetyl cellulose film having a thickness of 80 μm (Fujitack TD80U, produced by Fuji Photo Film Co., Ltd.) using a gravure coater. The coated film was dried at 100° C., and then irradiated with ultraviolet rays at an illuminance of 400 mW/cm² and a dose of 300 mJ/cm² from an air-cooled metal halide lamp having an output of 160 W/cm (produced by EYE GRAPHICS CO., LTD.) in an atmosphere in which the air within had been purged with nitrogen to reach an oxygen concentration of 1.0 vol-% so that the coat layer was cured to form a hard coat layer to a thickness of 8 μm.

The middle refractive index layer coating solution, the high refractive index layer coating solution and the low refractive index layer coating solution were continuously spread over the hard coat layer using a gravure coater having three coating stations.

The drying conditions of the middle refractive layer were 100° C. and 2 minutes. Referring to the ultraviolet curing conditions, the air in the atmosphere was purged with nitrogen so that the oxygen concentration reached 1.0 vol-%. In this atmosphere, ultraviolet rays were emitted at an illuminance of 400 mW/cm² and a dose of 400 mJ/cm² by an air-cooled metal halide lamp having an output of 180 W/cm (produced by EYE GRAPHICS CO., LTD.). The middle refractive layer thus cured had a refractive index of 1.630 and a thickness of 67 nm.

The drying conditions of the high refractive layer and the low refractive layer were 90° C. and 1 minute followed by 100° C. and 1 minute. Referring to the ultraviolet curing conditions, the air in the atmosphere was purged with nitrogen so that the oxygen concentration reached 1.0 vol-%. In this atmosphere, ultraviolet rays were emitted at an illuminance of 600 mW/cm and a dose of 600 mJ/cm² by an air-cooled metal halide lamp having an output of 240 W/cm (produced by EYE GRAPHICS CO., LTD.).

The high refractive index layer thus cured had a refractive index of 1.905 and a thickness of 107 nm and the low refractive layer thus cured had a refractive index of 1.440 and a thickness of 85 nm. Thus, a transparent protective layer TAC02 having an anti-reflection layer was prepared.

(Preparation of Polarizing Plate B)

Iodine was adsorbed to the polyvinyl alcohol film thus stretched to prepare a polarizer.

The surface of the transparent protective layer TAC02 with light-scattering layer thus prepared was then subjected to alkaline saponification. The transparent protective layer thus saponified was stuck to one side of the polarizer on the side thereof opposite the functional layer with a polyvinyl alcohol-based adhesive.

The optically-compensatory sheets (L12, L13, L23, L24, L32, L42 and L53) prepared in Examples 3-1 to 3-4 were each subjected to glow discharge treatment (a high frequency voltage of 4,200 V having a frequency of 3,000 Hz is applied across upper and lower electrodes for 20 seconds), stuck to the opposite side of the polarizing plate on the base film side thereof with a polyvinyl alcohol-based adhesive, and then dried at 70° C. for 10 minutes or more.

Arrangement was made such that the transmission axis of the polarizer and the slow axis of the optically-compensatory sheets prepared in Examples 3-1 to 3-4 were disposed parallel to each other and the transmission axis of the polarizer and the slow axis of the transparent protective layer TAC02 with light-scattering layer were disposed perpendicular to each other. Thus, polarizing plates (B-12, B-13, B-23, B-24, B-31, B-42 and B-53) were prepared.

### Example 4-3

### Preparation of Polarizing Plate C

Iodine was adsorbed to the polyvinyl alcohol film thus stretched to prepare a polarizer.

The surface of a triacetyl cellulose film (Fujitac TD80UF, produced by Fuji Photo Film Co., Ltd.) having a thickness of 80 μm was then subjected to alkaline saponification. The transparent protective layer thus saponified was stuck to one side of the polarizer on the side thereof opposite the functional layer with a polyvinyl alcohol-based adhesive.

The optically-compensatory sheets (L12, L13, L23, L24, L31, L42 and L52) prepared in Examples 3-1 to 3-4 were each subjected to glow discharge treatment (a high frequency voltage of 4,200 V having a frequency of 3,000 Hz is applied across upper and lower electrodes for 20 seconds), stuck to the opposite side of the polarizing plate on the base film side thereof with a polyvinyl alcohol-based adhesive, and then dried at 70° C. for 10 minutes or more.

Arrangement was made such that the transmission axis of the polarizer and the slow axis of the optically-compensatory sheets prepared in Examples 3-1 to 3-4 were disposed parallel to each other and the transmission axis of the polarizer and the slow axis of the transparent protective layer Fujitac TD80UF were disposed perpendicular to each other. Thus, polarizing plates (C-12, C-13, C-23, C-24, C-31, C-42 and C-53) were prepared.

### Comparative Example 1

### Preparation of Cellulose Acetate Dope

A cellulose acetate having an acetyl substitution degree of 2.79, a plasticizer (2:1 mixture of triphenyl phosphate and biphenyl diphenyl phosphate) and a solvent (87/13 (by mass) mixture of dichloromethane and methanol) were mixed with stirring to make a solution which was heated to a temperature of from 70° C. to 90° C. in a sealed pressure vessel and then filtered to prepare a dope.

The following composition containing the cellulose acetate solution prepared according to the aforementioned method was charged in a dispersing machine to prepare various matting agent dispersions.

TABLE 11
Matting agent dispersion

| | |
|---|---|
| Particulate silica having average particle diameter of | 2.0 parts by mass |
| 16 nm (Aerosil R972, produced by NIPPON | |
| AEROSIL CO., LTD.) | |
| Methylene chloride | 72.4 parts by mass |
| Methanol | 10.8 parts by mass |
| Cellulose acetate solution | 10.3 parts by mass |

Subsequently, the following composition containing the cellulose acetate solution prepared above was put in a mixing tank where it was then stirred to make a retardation developer solution.

TABLE 12

| Retardation developer solution | |
|---|---|
| Retardation developer shown below | 20.0 parts by mass |
| Methylene chloride | 58.3 parts by mass |
| Methanol | 8.7 parts by mass |
| Cellulose acetate solution | 12.8 parts by mass |

Subsequently, the following composition containing the cellulose acetate solution prepared above was put in a mixing tank where it was then stirred to make a UV absorber solution.

TABLE 13
UV absorber solution

| | | |
|---|---|---|
| Ultraviolet absorber (Sumisorb 165F) | 20.0 | parts by mass |
| Methyl acetate | 67.0 | parts by mass |
| Cellulose acetate solution | 12.8 | parts by mass |
| Retardation developer | | |
| 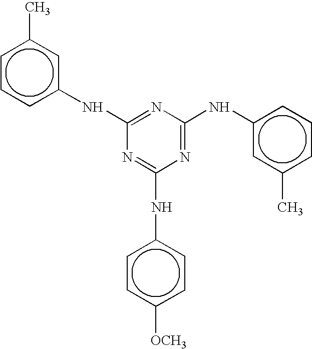 | | |

(Formation of Cellulose Acetate Film)

The cellulose acetate solution thus prepared was fed through a gear pump. In the course of pumping, a matting agent dispersion, a retardation developer solution and a UV absorber solution were injected in a specified amount. These components were uniformly mixed in a static mixer, and then casted using a band casting machine. The formulation of the casting dope is set forth in Table 14. Subsequently, the film which had been peeled of the band with the residual amount of solvent kept at 25 to 35% by mass was dried stretched crosswise while being held by a tenter and blown with hot air, and then moved from the tenter to rolls over which it was conveyed, dried, knurled, and then wound up at a width of 1,440 mm.

Subsequently, a 1.5 mol/l aqueous solution of sodium hydroxide was prepared. The aqueous solution was then kept at 55° C. Separately, a 0.005 mol/l dilute aqueous ink solution of sulfuric acid was prepared. The aqueous solution was then kept at 35° C. The cellulose acetate film thus prepared was dipped in the aforementioned aqueous solution of sodium hydroxide for 2 minutes, and then dipped in water so that the aqueous solution of sodium hydroxide was thoroughly washed away. Subsequently, the cellulose acetate film was dipped in the aforementioned dilute aqueous solution of sulfuric acid for 1 minute, and then dipped in water so that the diluted aqueous solution of sulfuric acid was thoroughly washed away. Eventually, the samples were each thoroughly dried at 120 C to prepare cellulose acetate films C1 and C2. All the cellulose acetate films showed a residual solvent content of 0.2% by mass or less. The characteristics and stretching ratio of the films thus obtained are set forth in Table 14.

TABLE 14

| | Dope formulation (%) | | | | Film characteristics | | | |
|---|---|---|---|---|---|---|---|---|
| | Cellulose | Retardation | UV | | Water | | | |
| | acetate | developer | absorber | Stretching | content | Thickness | Re | Rth |
| Film | solution | solution | solution | ratio (%) | (%) | (μm) | (nm) | (nm) |
| C1 | 17 | 0.87 | 0 | 16 | 1.87 | 92 | 40 | 200 |
| C2 | 17 | 0 | 0.18 | 2 | 2.22 | 92 | 8 | 80 |

(Preparation of Ring-Opening Polymerized Cyclic Polyolefin Dope)

The following compositions were charged in a mixing tank where they were then stirred to make a solution which was then filtered through a filter paper having an average pore diameter of 34 μm and a sintered metal filter having an average pore diameter of 10 μm.

TABLE 15

| Cyclic polyolefin solution D-3 | |
|---|---|
| Arton G (produced by JSR Co., Ltd.) | 150 parts by mass |
| Methylene chloride | 550 parts by mass |
| Ethanol | 50 parts by mass |

Subsequently, the following composition containing a ring-opening polymerized polyolefin solution prepared by the aforementioned method was charged in a dispersing machine to prepare a matting agent dispersion.

TABLE 16
Matting agent dispersion

| | |
|---|---|
| Particulate silica having average particle diameter of | 2 parts by mass |
| 16 nm (Aerosil R972, produced by NIPPON | |
| AEROSIL CO., LTD.) | |
| Methylene chloride | 75 parts by mass |
| Methanol | 5 parts by mass |
| Cyclic olefin-based addition polymer solution D-3 | 10 parts by mass |

100 parts by mass of the aforementioned cyclic polyolefin solution and 1.1 parts by mass of the aforementioned matting agent dispersion were then mixed to prepare a dope for film formation.

The dope was cast using a band caster. A film which was peeled off from the band at the time when the remaining solvent amount was about 22% by mass was stretched in the width direction at a stretching ratio of 50% using a tenter. After being conveyed by the tenter, the film was further conveyed by a roll, and was further dried at 120° C. to 140° C. and wound up. The resultant cyclic polyolefin film had a thickness of 60 μm and an in-plane retardation Re of 63 nm and a thickness-direction retardation Rth of 80 nm. This film was subjected to glow discharge treatment (a high frequency voltage of 4,200 V having a frequency of 3,000 Hz is applied across upper and lower electrodes for 20 seconds) between upper and lower brass electrodes (in an argon gas atmosphere) to prepare a ring-opening polymerized film C3. The surface of the film showed a contact angle of from 36° to 41° with respect to purified water.

### Comparative Example 3

### Optically-compensatory sheet CL-1

The cellulose acetate film C1 was coated with an oriented film, subjected to rubbing, and then coated with a discotic liquid crystal (optically anisotropic layer) in the same manner as in Example 3-1 to prepare an optically-compensatory sheet CL-1.

The optically anisotropic layer showed Re of 27 nm as measured by a Type KOBRA 21ADH automatic birefringence measuring instrument (produced by Ouji Scientific Instruments Co., Ltd.). Only the optically anisotropic layer was then peeled off the optically-compensatory sheet thus prepared. The optically anisotropic layer was then measured for β value and average direction of molecular asymmetric axis using a Type KOBRA 21ADH automatic birefringence measuring instrument (produced by Ouji Scientific Instruments Co., Ltd.). As a result, β value was 33°. The average direction of molecular asymmetric axis was 45.5° with respect to the longitudinal direction of the base cyclic olefin-based addition polymer film. For the calculation of p value, 1.6 was inputted as an average refractive index.

### Comparative Example 4

### Optically-Compensatory Sheets CL-2 and CL-3)

The film C2 prepared in Comparative Example 1 and the film C3 prepared in Comparative Example 2 were each coated with an oriented film, subjected to rubbing, and then coated with a discotic liquid crystal (optically anisotropic layer) in the same manner as in Example 3-2 to prepare optically-compensatory sheets CL-2 and CL-3.

The optically anisotropic layer showed Re of 46 nm as measured by a Type KOBRA 21ADH automatic birefringence measuring instrument (produced by Ouji Scientific Instruments Co., Ltd.). Only the optically anisotropic layer was then peeled off the optically-compensatory sheet thus prepared. The optically anisotropic layer was then measured for p value and average direction of molecular asymmetric axis using a Type KOBRA 21ADH automatic birefringence measuring instrument (produced by Ouji Scientific Instruments Co., Ltd.). As a result, β value was 38°. The average direction of molecular asymmetric axis was −0.3° with respect to the longitudinal direction of the base cyclic olefin-based addition polymer film. For the calculation of p value, 1.6 was inputted as an average refractive index.

### Comparative Example 5

The optically-compensatory sheets CL-1, CL-2 and CL-3 were processed in the same manner as in Example 4-1 to prepare polarizing plates CA-1, CA-2 and CA-3, respectively.

### Comparative Example 6

The optically-compensatory sheets CL-1, CL-2 and CL-3 were processed in the same manner as in Example 4-2 to prepare polarizing plates CB-1, CB-2 and CB-3, respectively.

### Comparative Example 7

The optically-compensatory sheets CL-1, CL-2 and CL-3 were processed in the same manner as in Example 4-3 to prepare polarizing plates CC-1, CC-2 and CC-3, respectively.

<Mounting on Liquid Crystal Display Device>

### Example 5-1

### Mounting on OCB Panel

A polyimide layer was provided as an oriented film on a glass substrate with ITO electrode. The oriented film was subjected to rubbing. Two sheets of the glass substrates thus obtained were laminated on each other in such an arrangement that the rubbing directions of the two sheets are parallel to each other. The cell gap was predetermined to be 5.7 μm. Into the cell gap was then injected a liquid crystal compound having Δn of 0.1396 “ZLI1132” (produced by Merck Co., Ltd.) to prepare a cell.

Any one of the polarizing plates A-31 and B-31 prepared in Examples 4-1 and 4-2 and the polarizing plates CA-1 and CB-1 prepared in Comparative Examples 5 and 6, and any one of the polarizing plates C-31 and CC-1 prepared in Example 4-3 and Comparative Example 7, respectively, were combined as a viewing side polarizing plate and a back light side polarizing plate, respectively. These polarizing plates were stuck to the OCB cell with an adhesive layer having a thickness of about 8 μm (Diabond DA 753, produced by NOGAWA CHEMICAL Co., Ltd.) in such an arrangement that the OCB cell was disposed interposed therebetween. Arrangement was made such that the optically anisotropic layer of the polarizing plate was opposed to the cell substrate and the rubbing direction of the liquid crystal cell and the rubbing direction of the optically anisotropic layer to which the liquid crystal cell is opposed are not parallel to each other to prepare liquid crystal display devices OCB-1 (inventive) and OCB-C1 (comparative). Further, the laminate was punched to form a 23″ wide rectangle such that the absorption axis was disposed at an angle of 45° from the longer side of the polarizing plate. The OCB cell to which the polarizing plates had been stuck was kept at 50° C. and 5 kg/cm² for 20 minutes to cause bonding.

The combinations of polarizing plates in liquid crystal display device are as follows.

OCB-1

(Polarizing plate A-31)—(OCB cell)—(polarizing plate C-31)

(Polarizing plate B-31)—(OCB cell)—(polarizing plate C-31)

OCB-CL

(Polarizing plate CA-1)—(OCB cell)—(polarizing plate CC-1)

(Polarizing plate CB-1)—(OCB cell)—(polarizing plate CC-1)

The liquid crystal display device thus prepared was disposed above a back light. A white display voltage of 2 V and a black display voltage of 4.5 V were then applied to the liquid crystal cell. Using a Type EZ-Contrast 160D measuring instrument (produced by ELDIM Inc.), the liquid crystal display device was then measured for brightness in black display and white display. From the measurements was then calculated the viewing angle (range within which the contrast ratio is 10 or more). All the polarizing plates provided as good viewing angle properties as extreme angle of 80° or more in all directions.

The inventive and comparative OCB mode liquid crystal display devices thus obtained were each turned ON. After 12 hours of aging, these OCB mode liquid crystal display devices were each compared for light leakage at the four corners of the screen. As a result, the comparative OCB mode liquid crystal display devices were observed to show light leakage while the inventive OCB mode liquid crystal display devices were observed to show little or no light leakage.

### Example 5-2

### Mounting on TN Panel

The polarizing plate A-12 prepared in Example 4-1 and the polarizing plate C-42 prepared in Example 4-3 were combined as back light side polarizing plate. These polarizing plates were together punched into a 17″ wide rectangle such that the absorption axis is disposed at an angle of 45° with respect to the longer side of the polarizing plate thus punched. The front and rear polarizing plates and the retarder film plate were peeled off a Type SynchMaster 172X TN mode liquid crystal monitor (produced by Samsung Corporation). The aforementioned polarizing plates were each then stuck to the front and back sides of the liquid crystal with an adhesive layer having a thickness of about 8 μm (Diabond DA 753, produced by NOGAWA CHEMICAL Co., Ltd.) to prepare an inventive liquid crystal display devices TN-1. After the sticking of polarizing plate, the liquid crystal display device was then kept at 50° C. and 5 kg/cm² for 20 minutes to complete adhesion. During this procedure, arrangement was made such that the optically anisotropic layer of the polarizing plate is opposed to the cell substrate and the rubbing direction of the liquid crystal cell and the rubbing direction of the optically anisotropic layer opposed to the liquid crystal cell are not parallel to each other.

Further, any one of the polarizing plates CA-2 and CB-2 prepared in Comparative Examples 5 and 6, respectively, and the polarizing plate CC-2 prepared in Comparative Example 7 were combined as viewing side polarizing plate and back light side polarizing plate. Using these polarizing plates, a comparative TN mode liquid crystal display device TN-C2 was prepared in the same manner as mentioned above.

Moreover, any one of the polarizing plates CA-3 and CB-3 prepared in Comparative Examples 5 and 6, respectively, and the polarizing plate CC-3 prepared in Comparative Example 7 were combined as viewing side polarizing plate and back light side polarizing plate. Using these polarizing plates, a comparative TN mode liquid crystal display device TN-C3 was prepared in the same manner as mentioned above.

The combinations of polarizing plates in liquid crystal display device are as follows.

TN-1

(Polarizing plate A-31)—(OCB cell)—(polarizing plate C-31)

(Polarizing plate B-31)—(OCB cell)—(polarizing plate C-31)

TN-C2

(Polarizing plate CA-2)—(OCB cell)—(polarizing plate CC-2)

(Polarizing plate CB-2)—(OCB cell)—(polarizing plate CC-2)

TN-C3

(Polarizing plate CA-3)—(OCB cell)—(polarizing plate CC-3)

(Polarizing plate CB-3)—(OCB cell)—(polarizing plate CC-3)

Using a Type EZ-Contrast 160D measuring instrument (produced by ELDIM Inc.), the liquid crystal display device was then measured for brightness in black display and white display. From the measurements was then calculated the viewing angle (range within which the contrast ratio is 10 or more). All the liquid crystal display devices TN-1 and TN-C2 provided as good viewing angle properties as extreme angle of 60° or more in all directions. However, the comparative liquid crystal display device TN-C3 provided viewing angle properties as low as 40° or less.

The inventive and comparative TN mode liquid crystal display devices TN-1 and TN-C2 were each turned ON. After 12 hours of aging, these TN mode liquid crystal display devices were each compared for light leakage at the four corners of the screen. As a result, the comparative TN mode liquid crystal display devices were observed to show light leakage while the inventive OCB mode liquid crystal display devices were observed to show little or no light leakage.

### Example 5-3

### Mounting on VA Panel

A liquid crystal cell was prepared by dropwise injecting a liquid crystal material having a negative dielectric anisotropy (“MLC6608,” produced by Merck Co., Ltd.) into the 3.6 μm gap between the substrates and then sealing the gap to form a liquid crystal layer. The retardation of the liquid crystal layer (i.e., product Δn·d of the thickness d (μm) and the refractive anisotropy Δn of the aforementioned liquid crystal layer) was predetermined to be 300 nm. The liquid crystal material was vertically aligned.

A polarizing plate C-0 was prepared in the same manner as in Example 4-3 except that a transparent protective film obtained by subjecting a polarizer Fujitac TD80UF to alkaline saponification on the front and back sides thereof was used. As the viewing side polarizing plate for the liquid crystal display device comprising the aforementioned vertically aligned liquid crystal cell there was used A-23 prepared in Example 4-1. As the back light side polarizing plate there was used the polarizing plate C-0. The polarizing plate prepared in the inventive example was then stuck to the cell with an adhesive layer having a thickness of about 8 μm (Diabond DA 753, produced by NOGAWA CHEMICAL Co., Ltd.) in such an arrangement that the optically anisotropic layer of A-23 was disposed on the liquid crystal cell side thereof. The liquid crystal cell was arranged in crossed Nicols such that the transmission axis of the viewing side polarizing plate runs vertically and the transmission axis of the back light side polarizing plate runs horizontally. Thus, a VA mode liquid crystal display device VA-1 was prepared.

Further, a VA mode liquid crystal display device VA-2 was prepared in the same manner as mentioned above except that B-53 prepared in Example 4-2 was disposed on the viewing side thereof.

Using a Type EZ-Contrast 160D measuring instrument (produced by ELDIM Inc.), the inventive VA mode liquid crystal display devices VA-1 and VA-2 were then measured for brightness in black display and white display. From the measurements was then calculated the viewing angle (range within which the contrast ratio is 10 or more). Both the liquid crystal display devices VA-1 and VA-2 provided as good viewing angle properties as extreme angle of 60° or more in all directions. These liquid crystal display devices were each turned ON. After 12 hours of aging, these liquid crystal display devices were each observed for light leakage at the four corners of the screen. As a result, these liquid crystal display devices were observed to show no light leakage.

1. An optically-compensatory sheet, comprising:
a base film containing a cyclic olefin-based addition polymer; and
an optically anisotropic layer laminated directly or indirectly on the base film.

2. The optically-compensatory sheet according to claim 1, wherein the cyclic olefin-based addition polymer is a copolymer comprising at least one repeating unit represented by the following formula (I) and at least one cyclic repeating unit represented by the following formula (II): 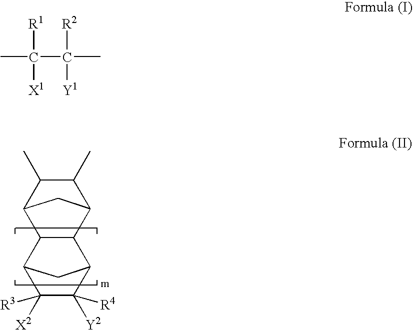
wherein m represents an integer of from 0 to 4;
R¹ to R⁴ each represents a hydrogen atom or a C₁-C₁₀ hydrocarbon group; and
X¹ to X² and Y¹ to Y² each represents a hydrogen atom, a C₁-C₁₀ hydrocarbon group, a halogen atom, a C₁-C₁₀ hydrocarbon group substituted by halogen atom, —(CH₂)ₙCOOR¹¹, —(CH₂)ₙOOCR¹²—(CH₂)ₙNCO, —(CH₂)ₙNO₂, —(CH₂)ₙCN, —(CH₂)ₙCONR¹³R¹⁴, —(CH₂)ₙNR¹³R¹⁴, —(CH₂)ₙOCOZ, —(CH₂)ₙOZ, —(CH₂)ₙW or (—CO)₂O or (—CO)₂NR¹⁵ formed by X¹ and Y¹ or X² and Y² in which R¹¹, R¹², R¹³, R¹⁴ and R¹⁵ each represents a C₁-C₂₀ hydrocarbon group, Z represents a hydrocarbon group or a hydrocarbon group substituted by halogen, W represents SiR¹⁶ₚD₃₋ₚ, in which R¹⁶ represents a C₁-C₁₀ hydrocarbon group, D represents a halogen atom, —OCOR¹⁶ or —OR¹⁶ and p represents an integer of from 0 to 3, and n represents an integer of from 0 to 10.

3. The optically-compensatory sheet according to claim 1, wherein the cyclic olefin-based addition polymer is a polymer comprising one cyclic repeating unit represented by the formula (II) or a copolymer comprising at least two cyclic repeating units represented by the formula (II).

4. The optically-compensatory sheet according to claim 3, wherein a thickness-direction retardation Rth of the optically-compensatory sheet satisfies the following expression:
40 nm≦Rth(630)≦300 nm
wherein Rth (λ) represents Rth measured at a wavelength of λ nm.

5. The optically-compensatory sheet according to claim 1, wherein the base film comprises a particulate material having a primary particle diameter of from 1 nm to 20 μm incorporated therein in a proportion of from 0.01% to 0.3% by mass.

6. The optically-compensatory sheet according to claim 1, wherein the optically anisotropic layer comprises a discotic liquid crystal layer.

7. The optically-compensatory sheet according to claim 1, wherein the optically anisotropic layer comprises a rod-shaped liquid crystal layer.

8. The optically-compensatory sheet according to claim 1, wherein the optically anisotropic layer comprises a polymer film.

9. The optically-compensatory sheet according to claim 8, wherein the polymer film constituting the optically anisotropic layer comprises at least one polymer material selected from the group consisting of polyamide, polyimide, polyester, polyether ketone, polyamide imide, polyester imide and polyaryl ether ketone.

10. The optically-compensatory sheet according to claim 1, wherein the base film containing the cyclic olefin-based addition polymer is formed through a step of flow-casting a solution as a start raw material on an endless metal support, the solution containing the cyclic olefin-based addition polymer by 10 to 35 mass % and a fluorine-based organic solvent as a main solvent, a step of drying the solution until remaining volatility reaches 5 to 60 mass %, a step of peeling the dried solution from the metal support with peeling resistance of 0.25 N/cm or less, and a step of drying and winding up the peeled solution.

11. The optically-compensatory sheet according to claim 10, wherein the fluorine-based organic solvent contains dichloromethane by 50 mass % or more, and the cyclic olefin-based addition polymer is dissolved at 20 to 100° C. to prepare the solution.

12. The optically-compensatory sheet according to claim 10, wherein the solution contains a poor solvent of the cyclic olefin-based addition polymer by 3 to 100 parts by mass for 100 parts by mass of the cyclic olefin-based addition polymer.

13. The optically-compensatory sheet according to claim 12, wherein the poor solvent comprises alcohols having boiling point of 120° C. or less.

14. The optically-compensatory sheet according to claim 1, wherein the base film containing the cyclic olefin-based addition polymer contains a surfactant by 0.05 to 3 mass %.

15. A polarizing plate, comprising:
a polarizer; and
two sheets of protective films disposed on the respective side thereof,
wherein at least one of the two sheets of the protective films is the optically-compensatory sheet according to claim 1.

16. A liquid crystal display device, comprising at least one sheet of the polarizing plate according to claim 15.
